(19) United States
(12) Patent Application Publication
(10) Pub. No.: US 2022/0217022 A1
(43) Pub. Date: Jul. 7, 2022

(54) Sequence Generation Method and Apparatus

(71) Applicant: Huawei Technologies Co., Ltd., Shenzhen (CN)

(72) Inventors: Dandan Liang, Shenzhen (CN); Ming Gan, Shenzhen (CN); Wei Lin, Shenzhen (CN); Mingjiang Wu, Chengdu (CN); Yang Yang, Chengdu (CN); Xianfu Lei, Chengdu (CN)

(21) Appl. No.: 17/693,662

(22) Filed: Mar. 14, 2022

Related U.S. Application Data
(63) Continuation of application No. PCT/CN2020/114611, filed on Sep. 10, 2020.

(30) Foreign Application Priority Data
Sep. 12, 2019 (CN) 201910869280.2

(51) Int. Cl. H04L 25/03; H04L 27/26

(52) U.S. Cl. CPC H04L 25/0391; H04L 2025/0377; H04L 25/03343; H04L 27/2614

(57) ABSTRACT

A sequence generation method, includes: generating a PPDU which comprises a matrix-mapped EHT LTF sequence, the matrix-mapped EHT LTF sequence is obtained by multiplying a predefined EHT LTF sequence by a P matrix, the P matrix is an n×n matrix, and n is greater than 8; and sending the PPDU, therefore the matrix-mapped EHT LTF sequence in a PPDU has a low PAPR value.

### CROSS-REFERENCE TO RELATED APPLICATIONS

This application is a continuation of International Application No. PCT/CN2020/114611, filed on Sep. 10, 2020, which claims priority to Chinese Patent Application No. 201910869280.2, filed on Sep. 12, 2019. The disclosures of the aforementioned applications are herein incorporated by reference in their entireties.

### TECHNICAL FIELD

Embodiments of this application relate to the communications field, and in particular, to a sequence generation method and an apparatus.

### BACKGROUND

Communications devices are more widely used over the past few years. For example, a communications device usually provides network access to, for example, a local area network or the internet. Other communications devices may perform wireless communication with the communications device that provides network access. Some communications devices comply with some industry standards such as Institute of Electrical and Electronics Engineers standards.

As a quantity of communications devices increase, people seek to improve capacities, reliability, and efficiency of the communications devices. Systems and methods for improving capacities, reliability, or efficiency of the communications devices may be helpful.

### SUMMARY

Embodiments of this application provide a sequence generation method and an apparatus, so that a matrix-mapped EHT LTF sequence in a PPDU has a low PAPR value.

According to a first aspect, an embodiment of this application provides a sequence generation method, including: obtaining a matrix-mapped EHT LTF sequence by multiplying a predefined EHT LTF sequence by a P matrix, where the P matrix is an n×n matrix, and n is greater than 8; and sending the matrix-mapped EHT LTF sequence.

Optionally, for the P matrix in the first aspect, refer to various P matrices in specific embodiments.

According to a second aspect, an embodiment of this application provides a sequence processing method, including: receiving a matrix-mapped EHT LTF sequence, where the matrix-mapped EHT LTF sequence is obtained by multiplying a predefined EHT LTF sequence by a P matrix, the P matrix is an n×n matrix, and n is greater than 8; and performing channel estimation based on the matrix-mapped EHT LTF sequence.

Optionally, for the P matrix in the second aspect, refer to various P matrices in specific embodiments.

According to a third aspect, an embodiment of this application provides a sequence generation method, including: generating a PPDU, where the PPDU includes a matrix-mapped EHT LTF sequence, the matrix-mapped EHT LTF sequence is obtained by multiplying a predefined EHT LTF sequence by a P matrix, the P matrix is an n×n matrix, and n is greater than 8; and sending the PPDU.

Optionally, for the P matrix in the third aspect, refer to various P matrices in specific embodiments.

According to a fourth aspect, an embodiment of this application provides a sequence processing method, including: receiving a PPDU, where the PPDU includes a matrix-mapped EHT LTF sequence, the matrix-mapped EHT LTF sequence is obtained by multiplying a predefined EHT LTF sequence by a P matrix, the P matrix is an n×n matrix, and n is greater than 8; and performing channel estimation based on the matrix-mapped EHT LTF sequence.

Optionally, for the P matrix in the fourth aspect, refer to various P matrices in specific embodiments.

According to a fifth aspect, an embodiment of this application provides a sequence generation apparatus, where the sequence generation apparatus includes modules configured to perform the method according to the first aspect or any possible implementation of the first aspect.

According to a sixth aspect, an embodiment of this application provides a sequence processing apparatus, where the sequence processing apparatus includes modules configured to perform the method according to the second aspect or any possible implementation of the second aspect.

According to a seventh aspect, an embodiment of this application provides a sequence generation apparatus, where the sequence generation apparatus includes modules configured to perform the method according to the third aspect or any possible implementation of the third aspect.

According to an eighth aspect, an embodiment of this application provides a sequence processing apparatus, where the sequence processing apparatus includes modules configured to perform the method according to the fourth aspect or any possible implementation of the fourth aspect.

According to a ninth aspect, an embodiment of this application provides a computer-readable storage medium, configured to store a computer program. The computer program includes instructions used to perform the first aspect or any possible implementation of the first aspect, instructions used to perform the second aspect or any possible implementation of the second aspect, instructions used to perform the third aspect or any possible implementation of the third aspect, or instructions used to perform the fourth aspect or any possible implementation of the fourth aspect.

According to a tenth aspect, an embodiment of this application provides a computer program. The computer program includes instructions used to perform the first aspect or any possible implementation of the first aspect, instructions used to perform the second aspect or any possible implementation of the second aspect, instructions used to perform the third aspect or any possible implementation of the third aspect, or instructions used to perform the fourth aspect or any possible implementation of the fourth aspect.

According to an eleventh aspect, an embodiment of this application provides a communications system, where the communications system includes the sequence generation apparatus provided in the fifth aspect and the sequence processing apparatus provided in the sixth aspect.

According to a twelfth aspect, an embodiment of this application provides a communications system, where the communications system includes the sequence generation apparatus provided in the seventh aspect and the sequence processing apparatus provided in the eighth aspect.

### BRIEF DESCRIPTION OF DRAWINGS

FIG. 1 shows a communications system to which an embodiment of this application is applied;

FIG. 2 is a diagram of a system;

FIG. 3 is a flowchart of a sequence generation method according to an embodiment of this application;

FIG. 4 is a diagram of a structure of a sequence generation apparatus; and

FIG. 5 is a diagram of a structure of a sequence receiving apparatus.

### DESCRIPTION OF EMBODIMENTS

The following describes the technical solutions in the embodiments of this application with reference to the accompanying drawings in the embodiments of this application.

It should be understood that, the technical solutions of the embodiments of this application may be applied to various communications systems, such as: a Wi-Fi wireless communications system, a global system for mobile communications (global system for mobile communications, GSM) system, a code division multiple access (code division multiple access, CDMA) system, a wideband code division multiple access (wideband code division multiple access, WCDMA) system, a general packet radio service (general packet radio service, GPRS) system, a long term evolution (long term evolution, LTE) system, an LTE frequency division duplex (frequency division duplex, FDD) system, an LTE time division duplex (time division duplex, TDD) system, a universal mobile telecommunications system (universal mobile telecommunications system, UMTS), a worldwide interoperability for microwave access (worldwide interoperability for microwave access, WiMAX) communications system, other future evolved systems, or various other wireless communications system using a radio access technology.

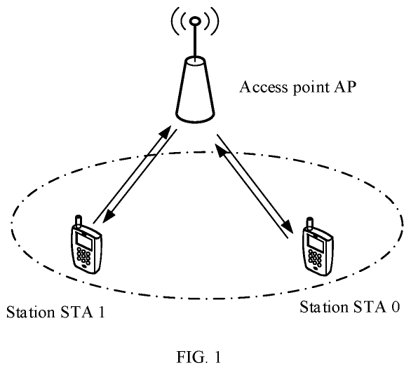

FIG. 1 shows a communications system to which an embodiment of this application is applied. The communications system includes a network device and at least one terminal device located within coverage of the network device. The network device may provide communication coverage for a specific geographic area, and communicate with the terminal device located in the coverage area. The network device may be a base transceiver station (base transceiver station, BTS) in a GSM system or a code division multiple access (code division multiple access, CDMA) system, may be a nodeB (nodeB, NB) in a WCDMA system, may be an evolved NodeB (evolved NodeB, eNB, or eNodeB) in an LTE system, may be a radio controller in a cloud radio access network (cloud radio access network, CRAN), or may be a relay station, an access point AP, a vehicle-mounted device, a wearable device, a network-side device in a future network, or the like. The terminal device may be mobile or fixed, and the terminal device may be a station STA, an access terminal, user equipment (user equipment, UE), a subscriber unit, a subscriber station, a mobile station, a remote station, a remote terminal, a mobile device, a user terminal, a wireless communications device, a user agent, a user apparatus, or the like.

Specifically, the embodiments of this application relate to a sequence generation method and a sequence generation apparatus. A sequence generated in the embodiments of this application has a low PAPR value.

Technical terms used in the embodiments of this application are first described as follows:
PPDU: PHY Protocol Data Unit, physical layer protocol data unit; and
EHT LTF: Extremely High Throughput Long Training Field, extremely high throughput long training field.

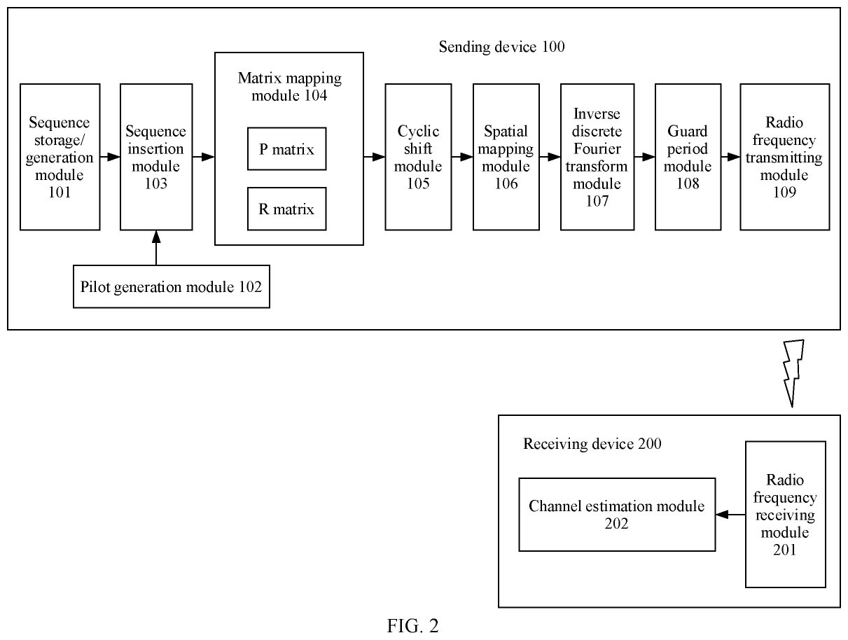

The following describes the sequence generation apparatus in the embodiments of this application by using FIG. 2 as an example.

FIG. 2 is a diagram of a system. The system includes a sending device 100 and a receiving device 200. The sending device 100 is configured to generate and send a sequence with a low PAPR value, and the receiving device 200 is configured to receive the sequence and perform channel estimation based on the sequence.

As shown in FIG. 2, the sending device 100 includes the following modules.

A sequence storage/generation module 101 is configured to store or generate a predefined data sequence (in the embodiments of this application, a sequence of data locations is collectively referred to as a data sequence), where the predefined data sequence includes a plurality of different sequences in different modes and different bandwidths, the different bandwidths may include a 20 M bandwidth, a 40 M bandwidth, an 80 M bandwidth, a 160 M bandwidth, a 320 M bandwidth, a 160M+160 M bandwidth, and the like, and the different modes may include a 1x mode, a 2x mode, a 4x mode, and the like. For example, the plurality of different sequences in the different modes and the different bandwidths include: a sequence in the 20 M bandwidth and the 1x mode, a sequence in the 20 M bandwidth and the 2x mode, a sequence in the 20 M bandwidth and the 4x mode, a sequence in the 40 M bandwidth and the 1x mode, a sequence in the 40 M bandwidth and the 2x mode, a sequence in the 40 M bandwidth and the 4x mode, . . . , a sequence in the 320 M bandwidth and the 1x mode, a sequence in the 320 M bandwidth and the 2x mode, and a sequence in the 320 M bandwidth and the 4x mode. Optionally, the data sequence is an EHT LTF sequence, that is, the sequence storage module 101 stores a predefined EHT LTF sequence.

A pilot generation module 102 is configured to generate a pilot sequence, where the pilot sequence is used to track a phase or a frequency offset of a transmit signal.

A pilot insertion module 103 is configured to insert the pilot sequence into the data sequence. In other words, the pilot insertion module 103 is configured to combine the pilot sequence and the data sequence.

A matrix mapping module 104 is configured to apply a matrix to the pilot sequence and the data sequence that are combined, to generate a matrix-mapped sequence. The matrix mapping module 104 includes a first matrix and a second matrix, where the first matrix provides a mapping for the data sequence and the second matrix provides a mapping for the pilot sequence. In other words, the first matrix is applied to the data sequence and the second matrix is applied to the pilot sequence. For convenience, the first matrix may be referred to as a P matrix, where the P matrix is an n×n matrix; and the second matrix may be referred to as an R matrix, where the R matrix includes x replicas of a first row of the P matrix, and x is a quantity of spatial streams.

In an example, applying the P matrix to the EHT LTF sequence is specifically multiplying the EHT LTF sequence by an element in the P matrix, for example, multiplying the EHT LTF sequence by each row of the P matrix, to obtain a plurality of matrix-mapped sequences, where the plurality of matrix-mapped sequences is spatially mapped to a plurality of different spatial streams for sending.

The n×n P matrix (n is greater than 8) provided in this embodiment of this application is intended to ensure that when the quantity of spatial streams increases to more than 8, a matrix-mapped sequence sent in each spatial stream needs to remain orthogonal and has a low PAPR value.

In this embodiment of this application, when the quantity of spatial streams is n and n is an even number, the n×n P matrix is applied. When the quantity of spatial streams is n and n is an odd number, an (n+1)×(n+1) P matrix is applied.

The following describes P matrices for different quantities of spatial streams provided in this embodiment of this application. The P matrix has a plurality of variations for each spatial stream.

(1) P Matrix for 9 or 10 Spatial Streams

When the quantity of spatial streams is 9 or 10, the P matrix provided in this embodiment of this application is:

$$\begin{matrix}{P}_{10 \times 10} = [ \begin{matrix}{P}_{5 \times 5} & {P}_{5 \times 5} \\ {P}_{5 \times 5} & - {P}_{5 \times 5}\end{matrix} ] & ( 11 ) \\ where & \\ {P}_{5 \times 5} = [ \begin{matrix}{w}^{0 * 0} & - {w}^{0 * 1} & {w}^{0 * 2} & {w}^{0 * 3} & {w}^{0 * 4} \\ {w}^{1 * 0} & - {w}^{1 * 1} & {w}^{1 * 2} & {w}^{1 * 3} & {w}^{1 * 4} \\ {w}^{2 * 0} & - {w}^{2 * 1} & {w}^{2 * 2} & {w}^{2 * 3} & {w}^{2 * 4} \\ {w}^{3 * 0} & - {w}^{3 * 1} & {w}^{3 * 2} & {w}^{3 * 3} & {w}^{3 * 4} \\ {w}^{4 * 0} & - {w}^{4 * 1} & {w}^{4 * 2} & {w}^{4 * 3} & {w}^{4 * 4}\end{matrix} ] , and w = exp ( - j 2 π / 5 ) & ( 12 )\end{matrix}$$

P_{5×5} in the foregoing formula (12) is obtained by multiplying the second column of P_{original} by −1, where P_{original} is expressed as follows:

$${P}_{original} = [ \begin{matrix}{w}^{0 * 0} & {w}^{0 * 1} & {w}^{0 * 2} & {w}^{0 * 3} & {w}^{0 * 4} \\ {w}^{1 * 0} & {w}^{1 * 1} & {w}^{1 * 2} & {w}^{1 * 3} & {w}^{1 * 4} \\ {w}^{2 * 0} & {w}^{2 * 1} & {w}^{2 * 2} & {w}^{2 * 3} & {w}^{2 * 4} \\ {w}^{3 * 0} & {w}^{3 * 1} & {w}^{3 * 2} & {w}^{3 * 3} & {w}^{3 * 4} \\ {w}^{4 * 0} & {w}^{4 * 1} & {w}^{4 * 2} & {w}^{4 * 3} & {w}^{4 * 4}\end{matrix} ] , and w = exp ( - j 2 π / 5 ) \qquad ( 13 )$$

For P_{5×5} in the foregoing formula (11), refer to the foregoing formula (12). P_{5×5} in the formula (12) is obtained by multiplying the second column of P_{original} in the formula (13) by −1. The foregoing is only an example of a P_{original} matrix when the quantity of spatial streams is 9 or 10 provided in this embodiment of this application.

Optionally, this embodiment of this application further provides another P₁₀₋₁₀ matrix when the quantity of spatial streams is 9 or 10:

$${P}_{10 \times 10} = [ \begin{matrix}{P}_{5 \times 5} & {P}_{5 \times 5} \\ {P}_{5 \times 5} & - {P}_{5 \times 5}\end{matrix} ] \qquad ( 11 )$$

P_{5×5} may be obtained by multiplying any one column of P_{original} by −1, or P_{5×5} may be obtained by multiplying any plurality of columns of P_{original} by −1, where the any plurality of columns herein do not include all columns. For example, the second column and the third column of P_{original} are multiplied by −1, to obtain P_{5×5}, but not all columns from the first column to the fifth column of P_{original} are multiplied by −1.

A matrix-mapped sequence obtained through mapping by using the foregoing P₁₀₋₁₀ has a low PAPR value. In the 80 M bandwidth and the 4x mode, a PAPR value of the matrix-mapped sequence obtained through mapping by using the foregoing P_{10×10} is 6.2771. When Fourier matrix mapping is directly applied, or Fourier matrix mapping in which one or more columns are multiplied by −1 is applied, a PAPR value of the obtained matrix-mapped sequence is 6.2851. It is clear that the PAPR value of the obtained matrix-mapped sequence is lower by using P_{10×10} provided in this embodiment of this application to map the EHT LTF sequence. Similarly, in the 320 M bandwidth and the 4x mode, a PAPR value of the matrix-mapped sequence obtained through mapping by using the foregoing P_{10×10} is 9.2297. When Fourier matrix mapping is directly applied, or Fourier matrix mapping in which one or more columns are multiplied by −1 is applied, a PAPR value of the obtained matrix-mapped sequence is 9.2653. It is clear that the PAPR value of the obtained matrix-mapped sequence is lower by using P_{10×10} provided in this embodiment of this application to map the EHT LTF sequence.

(2) P Matrix for 11 or 12 Spatial Streams

When the quantity of spatial streams is 11 or 12, the P matrix provided in this embodiment of this application is:

$$\begin{matrix}{P}_{12 \times 12} = [ \begin{matrix}{P}_{6 \times 6} & {P}_{6 \times 6} \\ {P}_{6 \times 6} & - {P}_{6 \times 6}\end{matrix} ] & ( 21 ) \\ where & \\ {P}_{6 \times 6} = [ \begin{matrix}{P}_{3 \times 3} & {P}_{3 \times 3} \\ {P}_{3 \times 3} & - {P}_{3 \times 3}\end{matrix} ] & ( 22 ) \\ {P}_{3 \times 3} = [ \begin{matrix}{w}^{0 * 0} & - {w}^{0 * 1} & {w}^{0 * 2} \\ {w}^{1 * 0} & - {w}^{1 * 1} & {w}^{1 * 2} \\ {w}^{2 * 0} & - {w}^{2 * 1} & {w}^{2 * 2}\end{matrix} ] , and w = exp ( - j 2 π / 3 ) & ( 23 )\end{matrix}$$

The foregoing P_{3×3} is obtained by multiplying the second column of the following P_{original} by −1, where P_{original} is expressed as follows:

$${P}_{original} = [ \begin{matrix}{w}^{0 * 0} & {w}^{0 * 1} & {w}^{0 * 2} \\ {w}^{1 * 0} & {w}^{1 * 1} & {w}^{1 * 2} \\ {w}^{2 * 0} & {w}^{2 * 1} & {w}^{2 * 2}\end{matrix} ] , and w = exp ( - j 2 π / 3 ) \qquad ( 24 )$$

P_{3×3} in the foregoing formula (23) is obtained by multiplying the second column of P_{original} in the formula (24) by −1. P_{3×3} in (23) is substituted into the formula (22), to obtain P_{6×6}. Then, P₆₋₆ in (23) is substituted into the formula (21) to obtain P₁₂₋₁₂.

Optionally, this embodiment of this application further provides another P_{12×12} matrix when the quantity of spatial streams is 11 or 12, for example, in the foregoing formula (21) to formula (24), P_{3×3} in (23) may be obtained by multiplying any one column of P_{original} in the formula (24) by −1. Multiplying the second column by −1 is not limited thereto. Alternatively, P_{3×3} in (23) may be obtained by multiplying any plurality of columns of P_{original} in the formula (24) by −1, where the any plurality of columns herein do not include all columns. For example, both the second column and the third column of P_{original} in (24) are multiplied by −1 to obtain P_{3×3} in (23), but not all columns from the first to the third columns of P_{original} in (24) are multiplied by −1.

A matrix-mapped sequence obtained through mapping by using the foregoing P_{12×12} has a low PAPR value. In the 80 M bandwidth and the 4x mode, a PAPR value of the matrix-mapped sequence obtained through mapping by using the foregoing P_{12×12} is 6.2369. When Fourier matrix mapping is directly applied, or Fourier matrix mapping in which one or more columns are multiplied by −1 is applied, a PAPR value of the obtained matrix-mapped sequence is 6.3003. It is clear that the PAPR value of the obtained matrix-mapped sequence is lower by using P_{10×10} provided in this embodiment of this application to map the EHT LTF sequence. Similarly, in the 320 M bandwidth and the 4x mode, a PAPR value of the matrix-mapped sequence obtained through mapping by using the foregoing P_{12×12} is 9.2236. When Fourier matrix mapping is directly applied, or Fourier matrix mapping in which one or more columns are multiplied by −1 is applied, a PAPR value of the obtained matrix-mapped sequence is 9.2636. It is clear that the PAPR value of the obtained matrix-mapped sequence is lower by using P_{12×12} provided in this embodiment of this application to map the EHT LTF sequence.

When the quantity of spatial streams is 11 or 12, this embodiment of this application further provides the following P matrix:

$$\begin{matrix}{P}_{12 \times 12} = [ \begin{matrix}{P}_{6 \times 6} & {P}_{6 \times 6} \\ {P}_{6 \times 6} & - {P}_{6 \times 6}\end{matrix} ] \\ & ( 31 ) \\ where & \\ {P}_{6 \times 6} = [ \begin{matrix}{w}^{0 * 0} & - {w}^{0 * 1} & {w}^{0 * 2} & {w}^{0 * 3} & {w}^{0 * 4} & - {w}^{0 * 5} \\ {w}^{1 * 0} & - {w}^{1 * 1} & {w}^{1 * 2} & {w}^{1 * 3} & {w}^{1 * 4} & - {w}^{1 * 5} \\ {w}^{2 * 0} & - {w}^{2 * 1} & {w}^{2 * 2} & {w}^{2 * 3} & {w}^{2 * 4} & - {w}^{2 * 5} \\ {w}^{3 * 0} & - {w}^{3 * 1} & {w}^{3 * 2} & {w}^{3 * 3} & {w}^{3 * 4} & - {w}^{3 * 5} \\ {w}^{4 * 0} & - {w}^{4 * 1} & {w}^{4 * 2} & {w}^{4 * 3} & {w}^{4 * 4} & - {w}^{4 * 5} \\ {w}^{5 * 0} & - {w}^{5 * 1} & {w}^{5 * 2} & {w}^{5 * 3} & {w}^{5 * 4} & - {w}^{5 * 5}\end{matrix} ] , and w = exp ( - j 2 π / 6 ) & ( 32 )\end{matrix}$$

P_{6×6} in the foregoing formula (32) is obtained by multiplying the second column and the sixth column of P_{original} in the following formula (33) by −1, where P_{original} is expressed as follows:

$${P}_{original} = [ \begin{matrix}{w}^{0 * 0} & {w}^{0 * 1} & {w}^{0 * 2} & {w}^{0 * 3} & {w}^{0 * 4} & {w}^{0 * 5} \\ {w}^{1 * 0} & {w}^{1 * 1} & {w}^{1 * 2} & {w}^{1 * 3} & {w}^{1 * 4} & {w}^{1 * 5} \\ {w}^{2 * 0} & {w}^{2 * 1} & {w}^{2 * 2} & {w}^{2 * 3} & {w}^{2 * 4} & {w}^{2 * 5} \\ {w}^{3 * 0} & {w}^{3 * 1} & {w}^{3 * 2} & {w}^{3 * 3} & {w}^{3 * 4} & {w}^{3 * 5} \\ {w}^{4 * 0} & {w}^{4 * 1} & {w}^{4 * 2} & {w}^{4 * 3} & {w}^{4 * 4} & {w}^{4 * 5} \\ {w}^{5 * 0} & {w}^{5 * 1} & {w}^{5 * 2} & {w}^{5 * 3} & {w}^{5 * 4} & {w}^{5 * 5}\end{matrix} ] , and w = exp ( - j 2 π / 6 ) \qquad ( 33 )$$

Optionally, this embodiment of this application further provides another P_{12×12} matrix when the quantity of spatial streams is 11 or 12, for example, in the foregoing formula (31) to formula (³³), P_{6×6} in (32) may be obtained by multiplying any one column of P_{original} in the formula (33) by −1. Alternatively, P_{6×6} in (32) may be obtained by multiplying any plurality of columns P_{original} in the formula (33) by −1, where the any plurality of columns herein do not include all columns. In addition to that the second column and the sixth column in the formula (32) are multiplied by −1, any other plurality of columns may be multiplied by −1. For example, the second column, the third column, and the fourth column of P_{original} in the formula (33) are multiplied by −1.

A matrix-mapped sequence obtained through mapping by using the foregoing P_{12×12} has a low PAPR value. In the 80 M bandwidth and the 4x mode, a PAPR value of the matrix-mapped sequence obtained through mapping by using the foregoing P_{12×12} is 6.2851. When Fourier matrix mapping is directly applied, or Fourier matrix mapping in which one or more columns are multiplied by −1 is applied, a PAPR value of the obtained matrix-mapped sequence is 6.3003. It is clear that the PAPR value of the obtained matrix-mapped sequence is lower by using P_{12×12} provided in this embodiment of this application to map the EHT LTF sequence. Similarly, in the 320 M bandwidth and the 4x mode, a PAPR value of the matrix-mapped sequence obtained through mapping by using the foregoing P_{12×12} is 9.2499. When Fourier matrix mapping is directly applied, or Fourier matrix mapping in which one or more columns are multiplied by −1 is applied, a PAPR value of the obtained matrix-mapped sequence is 9.2636. It is clear that the PAPR value of the obtained matrix-mapped sequence is lower by using P_{12×12} provided in this embodiment of this application to map the EHT LTF sequence.

(3) P matrix for 13 or 14 Spatial Streams

When the quantity of spatial streams is 13 or 14, this embodiment of this application provides the following P matrix:

$$\begin{matrix}{P}_{14 \times 14} = [ \begin{matrix}{P}_{7 \times 7} & {P}_{7 \times 7} \\ {P}_{7 \times 7} & - {P}_{7 \times 7}\end{matrix} ] & ( 41 ) \\ where & \\ {P}_{7 \times 7} = [ \begin{matrix}{w}^{0 * 0} & - {w}^{0 * 1} & {w}^{0 * 2} & {w}^{0 * 3} & {w}^{0 * 4} & - {w}^{0 * 5} & {w}^{0 * 6} \\ {w}^{1 * 0} & - {w}^{1 * 1} & {w}^{1 * 2} & {w}^{1 * 3} & {w}^{1 * 4} & - {w}^{1 * 5} & {w}^{1 * 6} \\ {w}^{2 * 0} & - {w}^{2 * 1} & {w}^{2 * 2} & {w}^{2 * 3} & {w}^{2 * 4} & - {w}^{2 * 5} & {w}^{2 * 6} \\ {w}^{3 * 0} & - {w}^{3 * 1} & {w}^{3 * 2} & {w}^{3 * 3} & {w}^{3 * 4} & - {w}^{3 * 5} & {w}^{3 * 6} \\ {w}^{4 * 0} & - {w}^{4 * 1} & {w}^{4 * 2} & {w}^{4 * 3} & {w}^{4 * 4} & - {w}^{4 * 5} & {w}^{4 * 6} \\ {w}^{5 * 0} & - {w}^{5 * 1} & {w}^{5 * 2} & {w}^{5 * 3} & {w}^{5 * 4} & - {w}^{5 * 5} & {w}^{5 * 6} \\ {w}^{6 * 0} & - {w}^{6 * 1} & {w}^{6 * 2} & {w}^{6 * 3} & {w}^{6 * 4} & - {w}^{6 * 5} & {w}^{6 * 6}\end{matrix} ] , and w = exp ( - j 2 π / 7 ) & ( 42 )\end{matrix}$$

P_{7×7} in the foregoing formula (42) is obtained by multiplying the second column and the sixth column of P_{original} in the following formula (43) by −1, where P_{original} is expressed as follows:

$${P}_{original} = [ \begin{matrix}{w}^{0 * 0} & {w}^{0 * 1} & {w}^{0 * 2} & {w}^{0 * 3} & {w}^{0 * 4} & {w}^{0 * 5} & {w}^{0 * 6} \\ {w}^{1 * 0} & {w}^{1 * 1} & {w}^{1 * 2} & {w}^{1 * 3} & {w}^{1 * 4} & {w}^{1 * 5} & {w}^{1 * 6} \\ {w}^{2 * 0} & {w}^{2 * 1} & {w}^{2 * 2} & {w}^{2 * 3} & {w}^{2 * 4} & {w}^{2 * 5} & {w}^{2 * 6} \\ {w}^{3 * 0} & {w}^{3 * 1} & {w}^{3 * 2} & {w}^{3 * 3} & {w}^{3 * 4} & {w}^{3 * 5} & {w}^{3 * 6} \\ {w}^{4 * 0} & {w}^{4 * 1} & {w}^{4 * 2} & {w}^{4 * 3} & {w}^{4 * 4} & {w}^{4 * 5} & {w}^{4 * 6} \\ {w}^{5 * 0} & {w}^{5 * 1} & {w}^{5 * 2} & {w}^{5 * 3} & {w}^{5 * 4} & {w}^{5 * 5} & {w}^{5 * 6} \\ {w}^{6 * 0} & {w}^{6 * 1} & {w}^{6 * 2} & {w}^{6 * 3} & {w}^{6 * 4} & {w}^{6 * 5} & {w}^{6 * 6}\end{matrix} ] , and w = exp ( - j 2 π / 7 ) \qquad ( 43 )$$

Optionally, this embodiment of this application further provides another P_{14×14} matrix when the quantity of spatial streams is 13 or 14, for example, in the foregoing formula (41) to formula (43), P_{7×7} in the formula (42) may be obtained by multiplying any one column of P_{original} in the formula (43) by −1. Alternatively, P_{7×7} in the formula (42) may be obtained by multiplying any plurality of columns of P_{original} in the formula (43) by −1, where the any plurality of columns herein do not include all columns. In addition to that the second column and the sixth column in the formula (42) are multiplied by −1, any other plurality of columns may be multiplied by −1. For example, the second column, the third column, and the fourth column of P_{original} in the formula (43) are multiplied by −1.

A matrix-mapped sequence obtained through mapping by using the foregoing P_{14×14} has a low PAPR value. In the 80 M bandwidth and the 4x mode, a PAPR value of the matrix-mapped sequence obtained through mapping by using the foregoing P_{14×14} is 6.3115. When Fourier matrix mapping is directly applied, or Fourier matrix mapping in which one or more columns are multiplied by −1 is applied, a PAPR value of the obtained matrix-mapped sequence is 6.3115. It is clear that the PAPR value of the obtained matrix-mapped sequence is lower by using P_{14×14} provided in this embodiment of this application to map the EHT LTF sequence. Similarly, in the 320 M bandwidth and the 4x mode, a PAPR value of the matrix-mapped sequence obtained through mapping by using the foregoing P_{14×14} is 9.2594. When Fourier matrix mapping is directly applied, or Fourier matrix mapping in which one or more columns are multiplied by −1 is applied, a PAPR value of the obtained matrix-mapped sequence is 9.2611. It is clear that the PAPR value of the obtained matrix-mapped sequence is lower by using P_{14×14} provided in this embodiment of this application to map the EHT LTF sequence.

(4) P Matrix for 17 or 18 Spatial Streams

When the quantity of spatial streams is 17 or 18, this embodiment of this application provides the following P matrix:

$$\begin{matrix} {P}_{18 \times 18} = [ \begin{matrix}{P}_{9 \times 9} & {P}_{9 \times 9} \\ {P}_{9 \times 9} & - {P}_{9 \times 9}\end{matrix} ] & ( 51 ) \\ where & \\ {P}_{9 \times 9} = & ( 52 ) \\ [ \begin{matrix}{w}^{0 * 0} & - {w}^{0 * 1} & {w}^{0 * 2} & {w}^{0 * 3} & {w}^{0 * 4} & - {w}^{0 * 5} & {w}^{0 * 6} & {w}^{0 * 7} & {w}^{0 * 8} \\ {w}^{1 * 0} & - {w}^{1 * 1} & {w}^{1 * 2} & {w}^{1 * 3} & {w}^{1 * 4} & - {w}^{1 * 5} & {w}^{1 * 6} & {w}^{1 * 7} & {w}^{1 * 8} \\ {w}^{2 * 0} & - {w}^{2 * 1} & {w}^{2 * 2} & {w}^{2 * 3} & {w}^{2 * 4} & - {w}^{2 * 5} & {w}^{2 * 6} & {w}^{2 * 7} & {w}^{2 * 8} \\ {w}^{3 * 0} & - {w}^{3 * 1} & {w}^{3 * 2} & {w}^{3 * 3} & {w}^{3 * 4} & - {w}^{3 * 5} & {w}^{3 * 6} & {w}^{3 * 7} & {w}^{3 * 8} \\ {w}^{4 * 0} & - {w}^{4 * 1} & {w}^{4 * 2} & {w}^{4 * 3} & {w}^{4 * 4} & - {w}^{4 * 5} & {w}^{4 * 6} & {w}^{4 * 7} & {w}^{4 * 8} \\ {w}^{5 * 0} & - {w}^{5 * 1} & {w}^{5 * 2} & {w}^{5 * 3} & {w}^{5 * 4} & - {w}^{5 * 5} & {w}^{5 * 6} & {w}^{5 * 7} & {w}^{5 * 8} \\ {w}^{6 * 0} & - {w}^{6 * 1} & {w}^{6 * 2} & {w}^{6 * 3} & {w}^{6 * 4} & - {w}^{6 * 5} & {w}^{6 * 6} & {w}^{6 * 7} & {w}^{6 * 8} \\ {w}^{7 * 0} & - {w}^{7 * 1} & {w}^{7 * 2} & {w}^{7 * 3} & {w}^{7 * 4} & - {w}^{7 * 5} & {w}^{7 * 6} & {w}^{7 * 7} & {w}^{7 * 8} \\ {w}^{8 * 0} & - {w}^{8 * 1} & {w}^{8 * 2} & {w}^{8 * 3} & {w}^{8 * 4} & - {w}^{8 * 5} & {w}^{8 * 6} & {w}^{8 * 7} & {w}^{8 * 8}\end{matrix} ] , & \\ and & \\ w = exp ( - j 2 π / 9 ) & \end{matrix}$$

P_{9×9} in the foregoing formula (52) is obtained by multiplying the second column and the sixth column of P_{original} in the following formula (53) by −1, where P_{original} is expressed as follows:

$${P}_{original} = \\ [ \begin{matrix}{w}^{0 * 0} & {w}^{0 * 1} & {w}^{0 * 2} & {w}^{0 * 3} & {w}^{0 * 4} & {w}^{0 * 5} & {w}^{0 * 6} & {w}^{0 * 7} & {w}^{0 * 8} \\ {w}^{1 * 0} & {w}^{1 * 1} & {w}^{1 * 2} & {w}^{1 * 3} & {w}^{1 * 4} & {w}^{1 * 5} & {w}^{1 * 6} & {w}^{1 * 7} & {w}^{1 * 8} \\ {w}^{2 * 0} & {w}^{2 * 1} & {w}^{2 * 2} & {w}^{2 * 3} & {w}^{2 * 4} & {w}^{2 * 5} & {w}^{2 * 6} & {w}^{2 * 7} & {w}^{2 * 8} \\ {w}^{3 * 0} & {w}^{3 * 1} & {w}^{3 * 2} & {w}^{3 * 3} & {w}^{3 * 4} & {w}^{3 * 5} & {w}^{3 * 6} & {w}^{3 * 7} & {w}^{3 * 8} \\ {w}^{4 * 0} & {w}^{4 * 1} & {w}^{4 * 2} & {w}^{4 * 3} & {w}^{4 * 4} & {w}^{4 * 5} & {w}^{4 * 6} & {w}^{4 * 7} & {w}^{4 * 8} \\ {w}^{5 * 0} & {w}^{5 * 1} & {w}^{5 * 2} & {w}^{5 * 3} & {w}^{5 * 4} & {w}^{5 * 5} & {w}^{5 * 6} & {w}^{5 * 7} & {w}^{5 * 8} \\ {w}^{6 * 0} & {w}^{6 * 1} & {w}^{6 * 2} & {w}^{6 * 3} & {w}^{6 * 4} & {w}^{6 * 5} & {w}^{6 * 6} & {w}^{6 * 7} & {w}^{6 * 8} \\ {w}^{7 * 0} & {w}^{7 * 1} & {w}^{7 * 2} & {w}^{7 * 3} & {w}^{7 * 4} & {w}^{7 * 5} & {w}^{7 * 6} & {w}^{7 * 7} & {w}^{7 * 8} \\ {w}^{8 * 0} & {w}^{8 * 1} & {w}^{8 * 2} & {w}^{8 * 3} & {w}^{8 * 4} & {w}^{8 * 5} & {w}^{8 * 6} & {w}^{8 * 7} & {w}^{8 * 8}\end{matrix} ] , \\ and w = exp ( - j 2 π / 9 ) \qquad ( 53 )$$

Optionally, this embodiment of this application further provides another P_{14×14} matrix when the quantity of spatial streams is 17 or 18, for example, in the foregoing formula (51) to formula (53), P_{9×9} in the formula (52) may be obtained by multiplying any one column of P_{original} in the formula (53) by −1. Alternatively, P_{9×9} in the formula (52) may be obtained by multiplying any plurality of columns of P_{original} in the formula (53) by −1, where the any plurality of columns herein do not include all columns. In addition to that the second column and the sixth column in the formula (52) are multiplied by −1, any other plurality of columns may be multiplied by −1. For example, the second column, the third column, and the fourth column of P_{original} in the formula (53) are multiplied by −1.

(5) P Matrix for 21 or 22 Spatial Streams

When the quantity of spatial streams is 21 or 22, this embodiment of this application provides the following P matrix:

$$\begin{matrix}{P}_{22 \times 22} = [ \begin{matrix}{P}_{11 \times 11} & {P}_{11 \times 11} \\ {P}_{11 \times 11} & - {P}_{11 \times 11}\end{matrix} ] \\ & ( 61 ) \\ where & \\ {P}_{11 \times 11} = [ \begin{matrix}{w}^{0 * 0} & - {w}^{0 * 1} & {w}^{0 * 2} & {w}^{0 * 3} & {w}^{0 * 4} & - {w}^{0 * 5} & {w}^{0 * 6} & {w}^{0 * 7} & {w}^{0 * 8} & - {w}^{0 * 9} & {w}^{0 * 10} \\ {w}^{1 * 0} & - {w}^{1 * 1} & {w}^{1 * 2} & {w}^{1 * 3} & {w}^{1 * 4} & - {w}^{1 * 5} & {w}^{1 * 6} & {w}^{1 * 7} & {w}^{1 * 8} & - {w}^{1 * 9} & {w}^{1 * 10} \\ {w}^{2 * 0} & - {w}^{2 * 1} & {w}^{2 * 2} & {w}^{2 * 3} & {w}^{2 * 4} & - {w}^{2 * 5} & {w}^{2 * 6} & {w}^{2 * 7} & {w}^{2 * 8} & - {w}^{2 * 9} & {w}^{2 * 10} \\ {w}^{3 * 0} & - {w}^{3 * 1} & {w}^{3 * 2} & {w}^{3 * 3} & {w}^{3 * 4} & - {w}^{3 * 5} & {w}^{3 * 6} & {w}^{3 * 7} & {w}^{3 * 8} & - {w}^{3 * 9} & {w}^{3 * 10} \\ {w}^{4 * 0} & - {w}^{4 * 1} & {w}^{4 * 2} & {w}^{4 * 3} & {w}^{4 * 4} & - {w}^{4 * 5} & {w}^{4 * 6} & {w}^{4 * 7} & {w}^{4 * 8} & - {w}^{4 * 9} & {w}^{4 * 10} \\ {w}^{5 * 0} & - {w}^{5 * 1} & {w}^{5 * 2} & {w}^{5 * 3} & {w}^{5 * 4} & - {w}^{5 * 5} & {w}^{5 * 6} & {w}^{5 * 7} & {w}^{5 * 8} & - {w}^{5 * 9} & {w}^{5 * 10} \\ {w}^{6 * 0} & - {w}^{6 * 1} & {w}^{6 * 2} & {w}^{6 * 3} & {w}^{6 * 4} & - {w}^{6 * 5} & {w}^{6 * 6} & {w}^{6 * 7} & {w}^{6 * 8} & - {w}^{6 * 9} & {w}^{6 * 10} \\ {w}^{7 * 0} & - {w}^{7 * 1} & {w}^{7 * 2} & {w}^{7 * 3} & {w}^{7 * 4} & - {w}^{7 * 5} & {w}^{7 * 6} & {w}^{7 * 7} & {w}^{7 * 8} & - {w}^{7 * 9} & {w}^{7 * 10} \\ {w}^{8 * 0} & - {w}^{8 * 1} & {w}^{8 * 2} & {w}^{8 * 3} & {w}^{8 * 4} & - {w}^{8 * 5} & {w}^{8 * 6} & {w}^{8 * 7} & {w}^{8 * 8} & - {w}^{8 * 9} & {w}^{8 * 10} \\ {w}^{9 * 0} & - {w}^{9 * 1} & {w}^{9 * 2} & {w}^{9 * 3} & {w}^{9 * 4} & - {w}^{9 * 5} & {w}^{9 * 6} & {w}^{9 * 7} & {w}^{9 * 8} & - {w}^{9 * 9} & {w}^{9 * 10} \\ {w}^{10 * 0} & - {w}^{10 * 1} & {w}^{10 * 2} & {w}^{10 * 3} & {w}^{10 * 4} & - {w}^{10 * 5} & {w}^{10 * 6} & {w}^{10 * 7} & {w}^{10 * 8} & - {w}^{10 * 9} & {w}^{10 * 10}\end{matrix} ] , and w = exp ( - j 2 π / 11 ) & ( 62 )\end{matrix}$$

P_{11×11} in the foregoing formula (62) is obtained by multiplying the second column, the sixth column, and the tenth column of P_{original} in the following formula (63) by −1, where P_{original} is expressed as follows:

$${P}_{original} = [ \begin{matrix}{w}^{0 * 0} & {w}^{0 * 1} & {w}^{0 * 2} & {w}^{0 * 3} & {w}^{0 * 4} & {w}^{0 * 5} & {w}^{0 * 6} & {w}^{0 * 7} & {w}^{0 * 8} & {w}^{0 * 9} & {w}^{0 * 10} \\ {w}^{1 * 0} & {w}^{1 * 1} & {w}^{1 * 2} & {w}^{1 * 3} & {w}^{1 * 4} & {w}^{1 * 5} & {w}^{1 * 6} & {w}^{1 * 7} & {w}^{1 * 8} & {w}^{1 * 9} & {w}^{1 * 10} \\ {w}^{2 * 0} & {w}^{2 * 1} & {w}^{2 * 2} & {w}^{2 * 3} & {w}^{2 * 4} & {w}^{2 * 5} & {w}^{2 * 6} & {w}^{2 * 7} & {w}^{2 * 8} & {w}^{2 * 9} & {w}^{2 * 10} \\ {w}^{3 * 0} & {w}^{3 * 1} & {w}^{3 * 2} & {w}^{3 * 3} & {w}^{3 * 4} & {w}^{3 * 5} & {w}^{3 * 6} & {w}^{3 * 7} & {w}^{3 * 8} & {w}^{3 * 9} & {w}^{3 * 10} \\ {w}^{4 * 0} & {w}^{4 * 1} & {w}^{4 * 2} & {w}^{4 * 3} & {w}^{4 * 4} & {w}^{4 * 5} & {w}^{4 * 6} & {w}^{4 * 7} & {w}^{4 * 8} & {w}^{4 * 9} & {w}^{4 * 10} \\ {w}^{5 * 0} & {w}^{5 * 1} & {w}^{5 * 2} & {w}^{5 * 3} & {w}^{5 * 4} & {w}^{5 * 5} & {w}^{5 * 6} & {w}^{5 * 7} & {w}^{5 * 8} & {w}^{5 * 9} & {w}^{5 * 10} \\ {w}^{6 * 0} & {w}^{6 * 1} & {w}^{6 * 2} & {w}^{6 * 3} & {w}^{6 * 4} & {w}^{6 * 5} & {w}^{6 * 6} & {w}^{6 * 7} & {w}^{6 * 8} & {w}^{6 * 9} & {w}^{6 * 10} \\ {w}^{7 * 0} & {w}^{7 * 1} & {w}^{7 * 2} & {w}^{7 * 3} & {w}^{7 * 4} & {w}^{7 * 5} & {w}^{7 * 6} & {w}^{7 * 7} & {w}^{7 * 8} & {w}^{7 * 9} & {w}^{7 * 10} \\ {w}^{8 * 0} & {w}^{8 * 1} & {w}^{8 * 2} & {w}^{8 * 3} & {w}^{8 * 4} & {w}^{8 * 5} & {w}^{8 * 6} & {w}^{8 * 7} & {w}^{8 * 8} & {w}^{8 * 9} & {w}^{8 * 10} \\ {w}^{9 * 0} & {w}^{9 * 1} & {w}^{9 * 2} & {w}^{9 * 3} & {w}^{9 * 4} & {w}^{9 * 5} & {w}^{9 * 6} & {w}^{9 * 7} & {w}^{9 * 8} & {w}^{9 * 9} & {w}^{9 * 10} \\ {w}^{10 * 0} & {w}^{10 * 1} & {w}^{10 * 2} & {w}^{10 * 3} & {w}^{10 * 4} & {w}^{10 * 5} & {w}^{10 * 6} & {w}^{10 * 7} & {w}^{10 * 8} & {w}^{10 * 9} & {w}^{10 * 10}\end{matrix} ] , and w = exp ( - j 2 π / 11 ) \qquad ( 63 )$$

Optionally, this embodiment of this application further provides another P_{22×22} matrix when the quantity of spatial streams is 21 or 22, for example, in the foregoing formula (61) to formula (63), P_{11×11} in the formula (62) may be obtained by multiplying any one column of P_{original} in the formula (63) by −1. Alternatively, P_{11×11} in the formula (62) may be obtained by multiplying any plurality of columns of P_{original} in the formula (63) by −1, where the any plurality of columns herein do not include all columns. In addition to that the second column, the sixth column, and the tenth column in the formula (62) are multiplied by −1, any other plurality of columns may be multiplied by −1. For example, the second column, the third column, and the fourth column of P_{original} in the formula (63) are multiplied by −1.

(6) P Matrix for 25 or 26 Spatial Streams

When the quantity of spatial streams is 25 or 26, the following P matrix provided in this embodiment of this application is:

$$\begin{matrix}{P}_{26 \times 26} = [ \begin{matrix}{P}_{13 \times 13} & {P}_{13 \times 13} \\ {P}_{13 \times 13} & - {P}_{13 \times 13}\end{matrix} ] & ( 71 ) \\ where & \\ {P}_{13 \times 13} = [ \begin{matrix}{w}^{0 * 0} & - {w}^{0 * 1} & {w}^{0 * 2} & {w}^{0 * 3} & {w}^{0 * 4} & - {w}^{0 * 5} & {w}^{0 * 6} & {w}^{0 * 7} & {w}^{0 * 8} & - {w}^{0 * 9} & {w}^{0 * 10} & {w}^{0 * 11} & {w}^{0 * 12} \\ {w}^{1 * 0} & - {w}^{1 * 1} & {w}^{1 * 2} & {w}^{1 * 3} & {w}^{1 * 4} & - {w}^{1 * 5} & {w}^{1 * 6} & {w}^{1 * 7} & {w}^{1 * 8} & - {w}^{1 * 9} & {w}^{1 * 10} & {w}^{0 * 11} & {w}^{0 * 12} \\ {w}^{2 * 0} & - {w}^{2 * 1} & {w}^{2 * 2} & {w}^{2 * 3} & {w}^{2 * 4} & - {w}^{2 * 5} & {w}^{2 * 6} & {w}^{2 * 7} & {w}^{2 * 8} & - {w}^{2 * 9} & {w}^{2 * 10} & {w}^{0 * 11} & {w}^{0 * 12} \\ {w}^{3 * 0} & - {w}^{3 * 1} & {w}^{3 * 2} & {w}^{3 * 3} & {w}^{3 * 4} & - {w}^{3 * 5} & {w}^{3 * 6} & {w}^{3 * 7} & {w}^{3 * 8} & - {w}^{3 * 9} & {w}^{3 * 10} & {w}^{0 * 11} & {w}^{0 * 12} \\ {w}^{4 * 0} & - {w}^{4 * 1} & {w}^{4 * 2} & {w}^{4 * 3} & {w}^{4 * 4} & - {w}^{4 * 5} & {w}^{4 * 6} & {w}^{4 * 7} & {w}^{4 * 8} & - {w}^{4 * 9} & {w}^{4 * 10} & {w}^{0 * 11} & {w}^{0 * 12} \\ {w}^{5 * 0} & - {w}^{5 * 1} & {w}^{5 * 2} & {w}^{5 * 3} & {w}^{5 * 4} & - {w}^{5 * 5} & {w}^{5 * 6} & {w}^{5 * 7} & {w}^{5 * 8} & - {w}^{5 * 9} & {w}^{5 * 10} & {w}^{0 * 11} & {w}^{0 * 12} \\ {w}^{6 * 0} & - {w}^{6 * 1} & {w}^{6 * 2} & {w}^{6 * 3} & {w}^{6 * 4} & - {w}^{6 * 5} & {w}^{6 * 6} & {w}^{6 * 7} & {w}^{6 * 8} & - {w}^{6 * 9} & {w}^{6 * 10} & {w}^{0 * 11} & {w}^{0 * 12} \\ {w}^{7 * 0} & - {w}^{7 * 1} & {w}^{7 * 2} & {w}^{7 * 3} & {w}^{7 * 4} & - {w}^{7 * 5} & {w}^{7 * 6} & {w}^{7 * 7} & {w}^{7 * 8} & - {w}^{7 * 9} & {w}^{7 * 10} & {w}^{0 * 11} & {w}^{0 * 12} \\ {w}^{8 * 0} & - {w}^{8 * 1} & {w}^{8 * 2} & {w}^{8 * 3} & {w}^{8 * 4} & - {w}^{8 * 5} & {w}^{8 * 6} & {w}^{8 * 7} & {w}^{8 * 8} & - {w}^{8 * 9} & {w}^{8 * 10} & {w}^{0 * 11} & {w}^{0 * 12} \\ {w}^{9 * 0} & - {w}^{9 * 1} & {w}^{9 * 2} & {w}^{9 * 3} & {w}^{9 * 4} & - {w}^{9 * 5} & {w}^{9 * 6} & {w}^{9 * 7} & {w}^{9 * 8} & - {w}^{9 * 9} & {w}^{9 * 10} & {w}^{0 * 11} & {w}^{0 * 12} \\ {w}^{10 * 0} & - {w}^{10 * 1} & {w}^{10 * 2} & {w}^{10 * 3} & {w}^{10 * 4} & - {w}^{10 * 5} & {w}^{10 * 6} & {w}^{10 * 7} & {w}^{10 * 8} & - {w}^{10 * 9} & {w}^{10 * 10} & {w}^{0 * 11} & {w}^{0 * 12} \\ {w}^{11 * 0} & - {w}^{11 * 1} & {w}^{11 * 2} & {w}^{11 * 3} & {w}^{11 * 4} & - {w}^{11 * 5} & {w}^{11 * 6} & {w}^{11 * 7} & {w}^{11 * 8} & - {w}^{11 * 9} & {w}^{11 * 10} & {w}^{11 * 11} & {w}^{11 * 12} \\ {w}^{12 * 0} & - {w}^{12 * 1} & {w}^{12 * 2} & {w}^{12 * 3} & {w}^{12 * 4} & - {w}^{12 * 5} & {w}^{12 * 6} & {w}^{12 * 7} & {w}^{12 * 8} & - {w}^{12 * 9} & {w}^{12 * 10} & {w}^{12 * 11} & {w}^{12 * 12}\end{matrix} ] , and w = exp ( - j 2 π / 13 ) & ( 72 )\end{matrix}$$

P_{13×13} in the foregoing formula (72) is obtained by multiplying the second column, the sixth column, and the tenth column of P_{original} in the following formula (73) by −1, where P_{original} is expressed as follows:

$${P}_{original} = [ \begin{matrix}{w}^{0 * 0} & {w}^{0 * 1} & {w}^{0 * 2} & {w}^{0 * 3} & {w}^{0 * 4} & {w}^{0 * 5} & {w}^{0 * 6} & {w}^{0 * 7} & {w}^{0 * 8} & {w}^{0 * 9} & {w}^{0 * 10} & {w}^{0 * 11} & {w}^{0 * 12} \\ {w}^{1 * 0} & {w}^{1 * 1} & {w}^{1 * 2} & {w}^{1 * 3} & {w}^{1 * 4} & {w}^{1 * 5} & {w}^{1 * 6} & {w}^{1 * 7} & {w}^{1 * 8} & {w}^{1 * 9} & {w}^{1 * 10} & {w}^{0 * 11} & {w}^{0 * 12} \\ {w}^{2 * 0} & {w}^{2 * 1} & {w}^{2 * 2} & {w}^{2 * 3} & {w}^{2 * 4} & {w}^{2 * 5} & {w}^{2 * 6} & {w}^{2 * 7} & {w}^{2 * 8} & {w}^{2 * 9} & {w}^{2 * 10} & {w}^{0 * 11} & {w}^{0 * 12} \\ {w}^{3 * 0} & {w}^{3 * 1} & {w}^{3 * 2} & {w}^{3 * 3} & {w}^{3 * 4} & {w}^{3 * 5} & {w}^{3 * 6} & {w}^{3 * 7} & {w}^{3 * 8} & {w}^{3 * 9} & {w}^{3 * 10} & {w}^{0 * 11} & {w}^{0 * 12} \\ {w}^{4 * 0} & {w}^{4 * 1} & {w}^{4 * 2} & {w}^{4 * 3} & {w}^{4 * 4} & {w}^{4 * 5} & {w}^{4 * 6} & {w}^{4 * 7} & {w}^{4 * 8} & {w}^{4 * 9} & {w}^{4 * 10} & {w}^{0 * 11} & {w}^{0 * 12} \\ {w}^{5 * 0} & {w}^{5 * 1} & {w}^{5 * 2} & {w}^{5 * 3} & {w}^{5 * 4} & {w}^{5 * 5} & {w}^{5 * 6} & {w}^{5 * 7} & {w}^{5 * 8} & {w}^{5 * 9} & {w}^{5 * 10} & {w}^{0 * 11} & {w}^{0 * 12} \\ {w}^{6 * 0} & {w}^{6 * 1} & {w}^{6 * 2} & {w}^{6 * 3} & {w}^{6 * 4} & {w}^{6 * 5} & {w}^{6 * 6} & {w}^{6 * 7} & {w}^{6 * 8} & {w}^{6 * 9} & {w}^{6 * 10} & {w}^{0 * 11} & {w}^{0 * 12} \\ {w}^{7 * 0} & {w}^{7 * 1} & {w}^{7 * 2} & {w}^{7 * 3} & {w}^{7 * 4} & {w}^{7 * 5} & {w}^{7 * 6} & {w}^{7 * 7} & {w}^{7 * 8} & {w}^{7 * 9} & {w}^{7 * 10} & {w}^{0 * 11} & {w}^{0 * 12} \\ {w}^{8 * 0} & {w}^{8 * 1} & {w}^{8 * 2} & {w}^{8 * 3} & {w}^{8 * 4} & {w}^{8 * 5} & {w}^{8 * 6} & {w}^{8 * 7} & {w}^{8 * 8} & {w}^{8 * 9} & {w}^{8 * 10} & {w}^{0 * 11} & {w}^{0 * 12} \\ {w}^{9 * 0} & {w}^{9 * 1} & {w}^{9 * 2} & {w}^{9 * 3} & {w}^{9 * 4} & {w}^{9 * 5} & {w}^{9 * 6} & {w}^{9 * 7} & {w}^{9 * 8} & {w}^{9 * 9} & {w}^{9 * 10} & {w}^{0 * 11} & {w}^{0 * 12} \\ {w}^{10 * 0} & {w}^{10 * 1} & {w}^{10 * 2} & {w}^{10 * 3} & {w}^{10 * 4} & {w}^{10 * 5} & {w}^{10 * 6} & {w}^{10 * 7} & {w}^{10 * 8} & {w}^{10 * 9} & {w}^{10 * 10} & {w}^{0 * 11} & {w}^{0 * 12} \\ {w}^{11 * 0} & {w}^{11 * 1} & {w}^{11 * 2} & {w}^{11 * 3} & {w}^{11 * 4} & {w}^{11 * 5} & {w}^{11 * 6} & {w}^{11 * 7} & {w}^{11 * 8} & {w}^{11 * 9} & {w}^{11 * 10} & {w}^{11 * 11} & {w}^{11 * 12} \\ {w}^{12 * 0} & {w}^{12 * 1} & {w}^{12 * 2} & {w}^{12 * 3} & {w}^{12 * 4} & {w}^{12 * 5} & {w}^{12 * 6} & {w}^{12 * 7} & {w}^{12 * 8} & {w}^{12 * 9} & {w}^{12 * 10} & {w}^{12 * 11} & {w}^{12 * 12}\end{matrix} ] , and w = exp ( - j 2 π / 13 )$$

Optionally, this embodiment of this application further provides another P_{26×26} matrix when the quantity of spatial streams is 25 or 26, for example, in the foregoing formula (71) to formula (73), P_{13×13} in the formula (72) may be obtained by multiplying any one column of P_{original} in the formula (73) by −1. Alternatively, P_{13×13} in the formula (72) may be obtained by multiplying any plurality of columns of P_{original} in the formula (73) by −1, where the any plurality of columns herein do not include all columns. In addition to that the second column, the sixth column, and the tenth column in the formula (72) are multiplied by −1, any other plurality of columns may be multiplied by −1. For example, the second column, the third column, and the fourth column of P_{original} in the formula (73) are multiplied by −1.

(7) P Matrix for 29 or 30 Spatial Streams

When the quantity of spatial streams is 29 or 30, the following P matrix provided in this embodiment of this application is:

$$\begin{matrix}{P}_{30 \times 30} = [ \begin{matrix}{P}_{15 \times 15} & {P}_{15 \times 15} \\ {P}_{15 \times 15} & - {P}_{15 \times 15}\end{matrix} ] \\ where & ( 81 ) \\ {P}_{15 \times 15} = \\ [ \begin{matrix}{w}^{0 * 0} & - {w}^{0 * 1} & {w}^{0 * 2} & {w}^{0 * 3} & {w}^{0 * 4} & - {w}^{0 * 5} & {w}^{0 * 6} & {w}^{0 * 7} & {w}^{0 * 8} & - {w}^{0 * 9} & {w}^{0 * 10} & {w}^{0 * 11} & {w}^{0 * 12} & - {w}^{0 * 13} & - {w}^{0 * 14} \\ {w}^{1 * 0} & - {w}^{1 * 1} & {w}^{1 * 2} & {w}^{1 * 3} & {w}^{1 * 4} & - {w}^{1 * 5} & {w}^{1 * 6} & {w}^{1 * 7} & {w}^{1 * 8} & - {w}^{1 * 9} & {w}^{1 * 10} & {w}^{1 * 11} & {w}^{1 * 12} & - {w}^{1 * 13} & - {w}^{1 * 14} \\ {w}^{2 * 0} & - {w}^{2 * 1} & {w}^{2 * 2} & {w}^{2 * 3} & {w}^{2 * 4} & - {w}^{2 * 5} & {w}^{2 * 6} & {w}^{2 * 7} & {w}^{2 * 8} & - {w}^{2 * 9} & {w}^{2 * 10} & {w}^{2 * 11} & {w}^{2 * 12} & - {w}^{2 * 13} & - {w}^{2 * 14} \\ {w}^{3 * 0} & - {w}^{3 * 1} & {w}^{3 * 2} & {w}^{3 * 3} & {w}^{3 * 4} & - {w}^{3 * 5} & {w}^{3 * 6} & {w}^{3 * 7} & {w}^{3 * 8} & - {w}^{3 * 9} & {w}^{3 * 10} & {w}^{3 * 11} & {w}^{3 * 12} & - {w}^{3 * 13} & - {w}^{3 * 14} \\ {w}^{4 * 0} & - {w}^{4 * 1} & {w}^{4 * 2} & {w}^{4 * 3} & {w}^{4 * 4} & - {w}^{4 * 5} & {w}^{4 * 6} & {w}^{4 * 7} & {w}^{4 * 8} & - {w}^{4 * 9} & {w}^{4 * 10} & {w}^{4 * 11} & {w}^{4 * 12} & - {w}^{4 * 13} & - {w}^{4 * 14} \\ {w}^{5 * 0} & - {w}^{5 * 1} & {w}^{5 * 2} & {w}^{5 * 3} & {w}^{5 * 4} & - {w}^{5 * 5} & {w}^{5 * 6} & {w}^{5 * 7} & {w}^{5 * 8} & - {w}^{5 * 9} & {w}^{5 * 10} & {w}^{5 * 11} & {w}^{5 * 12} & - {w}^{5 * 13} & - {w}^{5 * 14} \\ {w}^{6 * 0} & - {w}^{6 * 1} & {w}^{6 * 2} & {w}^{6 * 3} & {w}^{6 * 4} & - {w}^{6 * 5} & {w}^{6 * 6} & {w}^{6 * 7} & {w}^{6 * 8} & - {w}^{6 * 9} & {w}^{6 * 10} & {w}^{6 * 11} & {w}^{6 * 12} & - {w}^{6 * 13} & - {w}^{6 * 14} \\ {w}^{7 * 0} & - {w}^{7 * 1} & {w}^{7 * 2} & {w}^{7 * 3} & {w}^{7 * 4} & - {w}^{7 * 5} & {w}^{7 * 6} & {w}^{7 * 7} & {w}^{7 * 8} & - {w}^{7 * 9} & {w}^{7 * 10} & {w}^{7 * 11} & {w}^{7 * 12} & - {w}^{7 * 13} & - {w}^{7 * 14} \\ {w}^{8 * 0} & - {w}^{8 * 1} & {w}^{8 * 2} & {w}^{8 * 3} & {w}^{8 * 4} & - {w}^{8 * 5} & {w}^{8 * 6} & {w}^{8 * 7} & {w}^{8 * 8} & - {w}^{8 * 9} & {w}^{8 * 10} & {w}^{8 * 11} & {w}^{8 * 12} & - {w}^{8 * 13} & - {w}^{8 * 14} \\ {w}^{9 * 0} & - {w}^{9 * 1} & {w}^{9 * 2} & {w}^{9 * 3} & {w}^{9 * 4} & - {w}^{9 * 5} & {w}^{9 * 6} & {w}^{9 * 7} & {w}^{9 * 8} & - {w}^{9 * 9} & {w}^{9 * 10} & {w}^{9 * 11} & {w}^{9 * 12} & - {w}^{9 * 13} & - {w}^{9 * 14} \\ {w}^{10 * 0} & - {w}^{10 * 1} & {w}^{10 * 2} & {w}^{10 * 3} & {w}^{10 * 4} & - {w}^{10 * 5} & {w}^{0 * 6} & {w}^{10 * 7} & {w}^{10 * 8} & - {w}^{10 * 9} & {w}^{10 * 10} & {w}^{10 * 11} & {w}^{10 * 12} & - {w}^{10 * 13} & - {w}^{10 * 14} \\ {w}^{11 * 0} & - {w}^{11 * 1} & {w}^{11 * 2} & {w}^{11 * 3} & {w}^{11 * 4} & - {w}^{11 * 5} & {w}^{11 * 6} & {w}^{11 * 7} & {w}^{11 * 8} & - {w}^{11 * 9} & {w}^{11 * 10} & {w}^{11 * 11} & {w}^{11 * 12} & - {w}^{11 * 13} & - {w}^{11 * 14} \\ {w}^{12 * 0} & - {w}^{12 * 1} & {w}^{12 * 2} & {w}^{12 * 3} & {w}^{12 * 4} & - {w}^{12 * 5} & {w}^{12 * 6} & {w}^{12 * 7} & {w}^{12 * 8} & - {w}^{12 * 9} & {w}^{12 * 10} & {w}^{12 * 11} & {w}^{12 * 12} & - {w}^{12 * 13} & - {w}^{12 * 14} \\ {w}^{13 * 0} & - {w}^{13 * 1} & {w}^{13 * 2} & {w}^{13 * 3} & {w}^{13 * 4} & - {w}^{13 * 5} & {w}^{13 * 6} & {w}^{13 * 7} & {w}^{13 * 8} & - {w}^{13 * 9} & {w}^{13 * 10} & {w}^{13 * 11} & {w}^{13 * 12} & - {w}^{13 * 13} & - {w}^{13 * 14} \\ {w}^{14 * 0} & - {w}^{14 * 1} & {w}^{14 * 2} & {w}^{14 * 3} & {w}^{14 * 4} & - {w}^{14 * 5} & {w}^{14 * 6} & {w}^{14 * 7} & {w}^{14 * 8} & - {w}^{14 * 9} & {w}^{14 * 10} & {w}^{14 * 11} & {w}^{14 * 12} & - {w}^{14 * 13} & - {w}^{14 * 14}\end{matrix} ] , \\ and w = exp ( - j 2 π / 15 ) & ( 82 )\end{matrix}$$

P_{15×15} in the foregoing formula (82) is obtained by multiplying the second column, the sixth column, the tenth column, the fourteenth column, and the fifteenth column of P_{original} in the following formula (83) by −1, where P_{original} is expressed as follows:

$${P}_{original} = \\ [ \begin{matrix}{w}^{0 * 0} & {w}^{0 * 1} & {w}^{0 * 2} & {w}^{0 * 3} & {w}^{0 * 4} & {w}^{0 * 5} & {w}^{0 * 6} & {w}^{0 * 7} & {w}^{0 * 8} & {w}^{0 * 9} & {w}^{0 * 10} & {w}^{0 * 11} & {w}^{0 * 12} & {w}^{0 * 13} & {w}^{0 * 14} \\ {w}^{1 * 0} & {w}^{1 * 1} & {w}^{1 * 2} & {w}^{1 * 3} & {w}^{1 * 4} & {w}^{1 * 5} & {w}^{1 * 6} & {w}^{1 * 7} & {w}^{1 * 8} & {w}^{1 * 9} & {w}^{1 * 10} & {w}^{1 * 11} & {w}^{1 * 12} & {w}^{1 * 13} & {w}^{1 * 14} \\ {w}^{2 * 0} & {w}^{2 * 1} & {w}^{2 * 2} & {w}^{2 * 3} & {w}^{2 * 4} & {w}^{2 * 5} & {w}^{2 * 6} & {w}^{2 * 7} & {w}^{2 * 8} & {w}^{2 * 9} & {w}^{2 * 10} & {w}^{2 * 11} & {w}^{2 * 12} & {w}^{2 * 13} & {w}^{2 * 14} \\ {w}^{3 * 0} & {w}^{3 * 1} & {w}^{3 * 2} & {w}^{3 * 3} & {w}^{3 * 4} & {w}^{3 * 5} & {w}^{3 * 6} & {w}^{3 * 7} & {w}^{3 * 8} & {w}^{3 * 9} & {w}^{3 * 10} & {w}^{3 * 11} & {w}^{3 * 12} & {w}^{3 * 13} & {w}^{3 * 14} \\ {w}^{4 * 0} & {w}^{4 * 1} & {w}^{4 * 2} & {w}^{4 * 3} & {w}^{4 * 4} & {w}^{4 * 5} & {w}^{4 * 6} & {w}^{4 * 7} & {w}^{4 * 8} & {w}^{4 * 9} & {w}^{4 * 10} & {w}^{4 * 11} & {w}^{4 * 12} & {w}^{4 * 13} & {w}^{4 * 14} \\ {w}^{5 * 0} & {w}^{5 * 1} & {w}^{5 * 2} & {w}^{5 * 3} & {w}^{5 * 4} & {w}^{5 * 5} & {w}^{5 * 6} & {w}^{5 * 7} & {w}^{5 * 8} & {w}^{5 * 9} & {w}^{5 * 10} & {w}^{5 * 11} & {w}^{5 * 12} & {w}^{5 * 13} & {w}^{5 * 14} \\ {w}^{6 * 0} & {w}^{6 * 1} & {w}^{6 * 2} & {w}^{6 * 3} & {w}^{6 * 4} & {w}^{6 * 5} & {w}^{6 * 6} & {w}^{6 * 7} & {w}^{6 * 8} & {w}^{6 * 9} & {w}^{6 * 10} & {w}^{6 * 11} & {w}^{6 * 12} & {w}^{6 * 13} & {w}^{6 * 14} \\ {w}^{7 * 0} & {w}^{7 * 1} & {w}^{7 * 2} & {w}^{7 * 3} & {w}^{7 * 4} & {w}^{7 * 5} & {w}^{7 * 6} & {w}^{7 * 7} & {w}^{7 * 8} & {w}^{7 * 9} & {w}^{7 * 10} & {w}^{7 * 11} & {w}^{7 * 12} & {w}^{7 * 13} & {w}^{7 * 14} \\ {w}^{8 * 0} & {w}^{8 * 1} & {w}^{8 * 2} & {w}^{8 * 3} & {w}^{8 * 4} & {w}^{8 * 5} & {w}^{8 * 6} & {w}^{8 * 7} & {w}^{8 * 8} & {w}^{8 * 9} & {w}^{8 * 10} & {w}^{8 * 11} & {w}^{8 * 12} & {w}^{8 * 13} & {w}^{8 * 14} \\ {w}^{9 * 0} & {w}^{9 * 1} & {w}^{9 * 2} & {w}^{9 * 3} & {w}^{9 * 4} & {w}^{9 * 5} & {w}^{9 * 6} & {w}^{9 * 7} & {w}^{9 * 8} & {w}^{9 * 9} & {w}^{9 * 10} & {w}^{9 * 11} & {w}^{9 * 12} & {w}^{9 * 13} & {w}^{9 * 14} \\ {w}^{10 * 0} & {w}^{10 * 1} & {w}^{10 * 2} & {w}^{10 * 3} & {w}^{10 * 4} & {w}^{10 * 5} & {w}^{0 * 6} & {w}^{10 * 7} & {w}^{10 * 8} & {w}^{10 * 9} & {w}^{10 * 10} & {w}^{10 * 11} & {w}^{10 * 12} & {w}^{10 * 13} & {w}^{10 * 14} \\ {w}^{11 * 0} & {w}^{11 * 1} & {w}^{11 * 2} & {w}^{11 * 3} & {w}^{11 * 4} & {w}^{11 * 5} & {w}^{11 * 6} & {w}^{11 * 7} & {w}^{11 * 8} & {w}^{11 * 9} & {w}^{11 * 10} & {w}^{11 * 11} & {w}^{11 * 12} & {w}^{11 * 13} & {w}^{11 * 14} \\ {w}^{12 * 0} & {w}^{12 * 1} & {w}^{12 * 2} & {w}^{12 * 3} & {w}^{12 * 4} & {w}^{12 * 5} & {w}^{12 * 6} & {w}^{12 * 7} & {w}^{12 * 8} & {w}^{12 * 9} & {w}^{12 * 10} & {w}^{12 * 11} & {w}^{12 * 12} & {w}^{12 * 13} & {w}^{12 * 14} \\ {w}^{13 * 0} & {w}^{13 * 1} & {w}^{13 * 2} & {w}^{13 * 3} & {w}^{13 * 4} & {w}^{13 * 5} & {w}^{13 * 6} & {w}^{13 * 7} & {w}^{13 * 8} & {w}^{13 * 9} & {w}^{13 * 10} & {w}^{13 * 11} & {w}^{13 * 12} & {w}^{13 * 13} & {w}^{13 * 14} \\ {w}^{14 * 0} & {w}^{14 * 1} & {w}^{14 * 2} & {w}^{14 * 3} & {w}^{14 * 4} & {w}^{14 * 5} & {w}^{14 * 6} & {w}^{14 * 7} & {w}^{14 * 8} & {w}^{14 * 9} & {w}^{14 * 10} & {w}^{14 * 11} & {w}^{14 * 12} & {w}^{14 * 13} & {w}^{14 * 14}\end{matrix} ] , \\ and w = exp ( - j 2 π / 15 ) \qquad ( 83 )$$

Optionally, this embodiment of this application further provides another P_{30×30} matrix when the quantity of spatial streams is 29 or 30, for example, in the foregoing formula (81) to formula (83), P_{15×15} in the formula (82) may be obtained by multiplying any one column of P_{original} in the formula (83) by −1. Alternatively, P_{15×15} in the formula (82) may be obtained by multiplying any plurality of columns of P_{original} in the formula (83) by −1, where the any plurality of columns herein do not include all columns. In addition to that the second column, the sixth column, and the tenth column in the formula (82) are multiplied by −1, any other plurality of columns may be multiplied by −1. For example, the second column, the third column, and the fourth column of P_{original} in the formula (83) are multiplied by −1.

The sending device 100 further includes a cyclic shift module 105, a spatial mapping module 106, an inverse discrete Fourier transform module 107, a guard period module 108, and a radio frequency transmitting module 109. The matrix-mapped sequence obtained through mapping by using the foregoing P matrix is placed in a corresponding spatial stream for sending.

The receiving device 200 is configured to receive the matrix-mapped sequence sent by the sending device 100, and perform channel estimation based on the matrix-mapped sequence. As shown in FIG. 2, the receiving device 200 includes a radio frequency receiving module 201 and a channel estimation module 202. The radio frequency receiving module 201 is configured to receive the matrix-mapped sequence sent by the sending device 100, and the channel estimation module 202 is configured to perform channel estimation based on the matrix-mapped sequence.

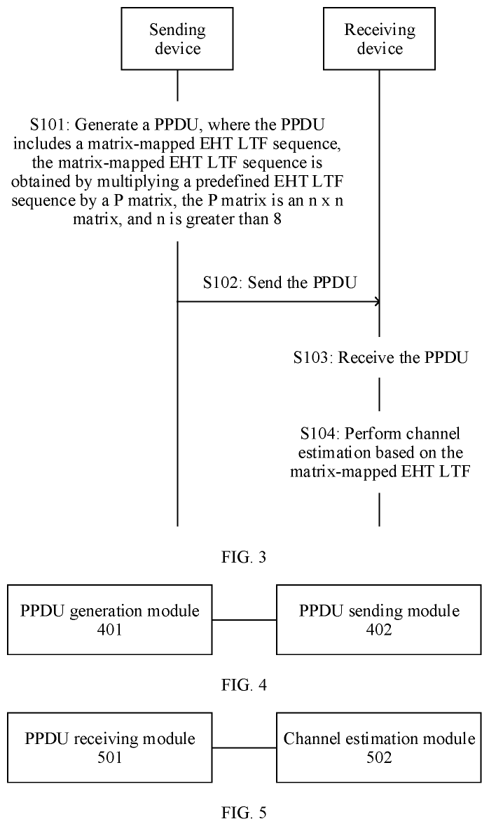

The following describes a sequence generation method in an embodiment of this application by using a procedure in FIG. 3 as an example.

As shown in FIG. 3, the sequence generation method includes the following steps.

S101: A sending device generates a PPDU, where the PPDU includes a matrix-mapped EHT LTF sequence, the matrix-mapped EHT LTF sequence is obtained by multiplying a predefined EHT LTF sequence by a P matrix, the P matrix is an n×n matrix, and n is greater than 8.

In step S101, the predefined EHT LTF sequence includes a plurality of different sequences in different modes and different bandwidths, the different bandwidths may include a 20 M bandwidth, a 40 M bandwidth, an 80 M bandwidth, a 160 M bandwidth, a 320 M bandwidth, a 160 M+160 M bandwidth, and the like, and the different modes may include a 1x mode, a 2x mode, a 4x mode, and the like. For example, the plurality of different sequences in the different modes and the different bandwidths include a sequence in the 20 M bandwidth and the 1x mode, a sequence in the 20 M bandwidth and the 2x mode, a sequence in the 20 M bandwidth and the 4x mode, a sequence in the 40 M bandwidth and the 1x mode, a sequence in the 40 M bandwidth and the 2x mode, a sequence in the 40 M bandwidth and the 4x mode, . . . , a sequence in the 320 M bandwidth and the 1x mode, a sequence in the 320 M bandwidth and the 2x mode, and a sequence in the 320 M bandwidth and the 4x mode.

The EHT LTF sequence is multiplied by each row of the P matrix, to obtain a plurality of matrix-mapped EHT LTF sequences, where the plurality of matrix-mapped EHT LTF sequences are spatially mapped to a plurality of different spatial streams for sending.

The n×n P matrix (n is greater than 8) provided in this embodiment of this application is intended to ensure that when the quantity of spatial streams increases to more than 8, a matrix-mapped sequence sent in each spatial stream needs to remain orthogonal and has a low PAPR value.

In this embodiment of this application, when the quantity of spatial streams is n and n is an even number, the n×n P matrix is applied. When the quantity of spatial streams is n and n is an odd number, an (n+1)×(n+1) P matrix is applied.

For various P matrices for different quantities of spatial streams, refer to the foregoing descriptions. Details are not described herein again.

S102: The sending device sends the PPDU.

S103: A receiving device receives the PPDU, where the PPDU includes the matrix-mapped EHT LTF sequence. The matrix-mapped EHT LTF sequence is obtained by multiplying the predefined EHT LTF sequence by the P matrix, the P matrix is an n×n matrix, and n is greater than 8.

S104: The receiving device performs channel estimation based on the matrix-mapped EHT LTF sequence.

In this embodiment of this application, the matrix-mapped EHT LTF sequence in the PPDU has a low PAPR value.

The sequence generation method in the embodiments of this application is described above. The following describes a sequence generation apparatus in an embodiment of this application. It should be understood that the sequence generation apparatus is the sending device in the foregoing method, and has any function of the sending device in the foregoing method.

As shown in FIG. 4, the sequence generation apparatus includes: a PPDU generation module 401, configured to generate a PPDU, where the PPDU includes a matrix-mapped EHT LTF sequence, the matrix-mapped EHT LTF sequence is obtained by multiplying a predefined EHT LTF sequence by a P matrix, the P matrix is an n×n matrix, and n is greater than 8; and a PPDU sending module 402, configured to send the PPDU.

The sequence generation apparatus in this embodiment of this application has any function of the sending device in the foregoing method. Details are not described herein again.

The following briefly describes a sequence receiving apparatus in an embodiment of this application. It should be understood that the sequence receiving apparatus is the receiving device in the foregoing method, and has any function of the receiving device in the foregoing method.

As shown in FIG. 5, the sequence receiving apparatus includes: a PPDU receiving module 501, configured to receive a PPDU, where the PPDU includes a matrix-mapped EHT LTF sequence, the matrix-mapped EHT LTF sequence is obtained by multiplying a predefined EHT LTF sequence by a P matrix, the P matrix is an n×n matrix, and n is greater than 8; and a channel estimation module 502, configured to perform channel estimation based on the matrix-mapped EHT LTF sequence.

The sequence receiving apparatus in this embodiment of this application has any function of the receiving device in the foregoing method. Details are not described herein again.

It should be understood that the P matrix applied to the EHT LTF sequence in the embodiments of this application may include, in addition to the P matrices enumerated in the foregoing embodiments, the P matrices mentioned in the processes of the foregoing embodiments, for example, P_{5×5}, P_{3×3}, P_{6×6}, P_{7×7}, P_{9×9}, P_{11×11}, P_{13×13}, and P_{15×15}, that is, the P matrices in FIG. 2 may directly use the foregoing P_{5×5}, P_{3×3}, P_{6×6}, P_{7×7}, P_{9×9}, P_{11×11}, P_{13×13},and P_{15×15}.

The sequence generation apparatus and the sequence receiving apparatus in the embodiments of this application are described above. The following describes possible product forms of the sequence generation apparatus and the sequence receiving apparatus. It should be understood that any product having functions of the sequence generation apparatus in FIG. 4 and any product having functions of the sequence receiving apparatus in FIG. 5 fall within the protection scope of the embodiments of this application. It should be further understood that the following description is merely an example, and product forms of the sequence generation apparatus and the sequence receiving apparatus in the embodiments of this application are not limited thereto.

In a possible product form, the sequence generation apparatus and the sequence receiving apparatus described in the embodiments of this application may be implemented by using a general bus architecture.

The sequence generation apparatus includes a processor and a transceiver that is internally connected to and communicates with the processor. The processor is configured to generate a PPDU, where the PPDU includes a matrix-mapped EHT LTF sequence, the matrix-mapped EHT LTF sequence is obtained by multiplying a predefined EHT LTF sequence by a P matrix, the P matrix is an n×n matrix, and n is greater than 8. The transceiver is configured to send the PPDU. Optionally, the sequence generation apparatus may further include a memory, where the memory is configured to store instructions executed by the processor.

The sequence receiving apparatus includes a processor and a transceiver that is internally connected to and communicates with the processor. The transceiver is configured to receive a PPDU, where the PPDU includes a matrix-mapped EHT LTF sequence, the matrix-mapped EHT LTF sequence is obtained by multiplying a predefined EHT LTF sequence by a P matrix, the P matrix is an n×n matrix, and n is greater than 8. The processor is configured to perform channel estimation based on the matrix-mapped EHT LTF sequence. Optionally, the sequence receiving apparatus may further include a memory, where the memory is configured to store instructions executed by the processor.

In a possible product form, the sequence generation apparatus and the sequence receiving apparatus described in the embodiments of this application may be implemented by using a general-purpose processor.

The general-purpose processor for implementing the sequence generation apparatus includes a processing circuit and an output interface that is internally connected to and communicates with the processing circuit. The processing circuit is configured to generate a PPDU, where the PPDU includes a matrix-mapped EHT LTF sequence, the matrix-mapped EHT LTF sequence is obtained by multiplying a predefined EHT LTF sequence by a P matrix, the P matrix is an n×n matrix, and n is greater than 8. The output interface is configured to send the PPDU. Optionally, the general-purpose processor may further include a storage medium, where the storage medium is configured to store instructions executed by the processing circuit.

The general-purpose processor for implementing the sequence receiving apparatus includes a processing circuit and an input interface that is internally connected to and communicates with the processing circuit. The input interface is configured to receive a PPDU, where the PPDU includes a matrix-mapped EHT LTF sequence, the matrix-mapped EHT LTF sequence is obtained by multiplying a predefined EHT LTF sequence by a P matrix, the P matrix is an n×n matrix, and n is greater than 8. The processing circuit is configured to perform channel estimation based on the matrix-mapped EHT LTF sequence. Optionally, the general-purpose processor may further include a storage medium, where the storage medium is configured to store instructions executed by the processing circuit.

In a possible product form, the sequence generation apparatus and the sequence receiving apparatus described in the embodiments of this application may alternatively be implemented by using the following: one or more FPGAs (Field Programmable Gate Arrays), PLDs (Programmable Logic Devices), controllers, state machines, gate logic, discrete hardware components, any other suitable circuits, or any combination of circuits capable of performing various functions described in this application.

It should be understood that the sequence generation apparatuses in the foregoing various product forms have any function of the sending device in the foregoing method embodiment, and details are not described herein again; and the sequence receiving apparatuses in the foregoing various product forms have any function of the receiving device in the foregoing method embodiment, and details are not described herein again.

It should be understood that the term “and/or” in this specification describes only an association relationship for describing associated objects and represents that three relationships may exist. For example, A and/or B may represent the following three cases: only A exists, both A and B exist, and only B exists. In addition, the character “/” in this specification usually indicates an “or” relationship between the associated objects.

A person of ordinary skill in the art may be aware that, in combination with the examples described in the embodiments disclosed in this specification, method steps and units may be implemented by electronic hardware, computer software, or a combination thereof. To clearly describe the interchangeability between hardware and software, the foregoing has generally described steps and compositions of each embodiment according to functions. Whether the functions are performed by hardware or software depends on particular applications and design constraint conditions of the technical solutions. The person of ordinary skill in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing described system, apparatus, and unit, refer to a corresponding process in the foregoing method embodiment, and details are not described herein again.

In the several embodiments provided in this application, it should be understood that the disclosed system, apparatus, and method may be implemented in other manners. For example, the described apparatus embodiment is merely an example. For example, division into units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electrical, mechanical, or other forms.

The units described as separate parts may or may not be physically separate, and parts displayed as units may or may not be physical units, may be located in one location, or may be distributed on a plurality of network units. A part or all of the units may be selected according to actual requirements to achieve the objectives of the solutions of the embodiments in this application.

In addition, functional units in the embodiments of this application may be integrated into one processing unit, or each of the units may exist alone physically, or two or more units may be integrated into one unit. The integrated unit may be implemented in a form of hardware, or may be implemented in a form of a software functional unit.

When the integrated unit is implemented in the form of a software function unit and is sold or used as an independent product, the integrated unit may be stored in a computer-readable storage medium. Based on such an understanding, the technical solutions in this application essentially, or the part contributing to the conventional technology, or all or a part of the technical solutions may be implemented in a form of a software product. The computer software product is stored in a storage medium and includes several instructions for instructing a computer device (which may be a personal computer, a server, a network device, or the like) to perform all or a part of the steps of the methods in the embodiments of this application. The foregoing storage medium includes: any medium that can store program code, such as a USB flash drive, a removable hard disk, a read-only memory (read-only memory, ROM), a random access memory (random access memory, RAM), a magnetic disk, or an optical disc.

The foregoing descriptions are merely specific embodiments of this application, but are not intended to limit the protection scope of this application. Any modification or replacement readily figured out by a person skilled in the art within the technical scope disclosed in this application shall fall within the protection scope of this application. Therefore, the protection scope of this application shall be subject to the protection scope of the claims.

What is claimed is:

1. A method, comprising:
generating a physical layer protocol data unit (PPDU), wherein the PPDU comprises a matrix-mapped extremely high throughput long training field (EHT LTF) sequence, the matrix-mapped EHT LTF sequence is obtained by multiplying a predefined EHT LTF sequence by a P matrix, the P matrix is an n×n matrix, and n is greater than 8; and
sending the PPDU.

2. The method according to claim 1, wherein when n=10, the P matrix is:
$${P}_{10 \times 10} = [ \begin{matrix}{P}_{5 \times 5} & {P}_{5 \times 5} \\ {P}_{5 \times 5} & - {P}_{5 \times 5}\end{matrix} ] , wherein {P}_{5 \times 5} = [ \begin{matrix}{w}^{0 * 0} & - {w}^{0 * 1} & {w}^{0 * 2} & {w}^{0 * 3} & {w}^{0 * 4} \\ {w}^{1 * 0} & - {w}^{1 * 1} & {w}^{1 * 2} & {w}^{1 * 3} & {w}^{1 * 4} \\ {w}^{2 * 0} & - {w}^{2 * 1} & {w}^{2 * 2} & {w}^{2 * 3} & {w}^{2 * 4} \\ {w}^{3 * 0} & - {w}^{3 * 1} & {w}^{3 * 2} & {w}^{3 * 3} & {w}^{3 * 4} \\ {w}^{4 * 0} & - {w}^{4 * 1} & {w}^{4 * 2} & {w}^{4 * 3} & {w}^{4 * 4}\end{matrix} ] , and w = exp ( - j 2 π / 5 ) .$$

3. The method according to claim 1, wherein when n=12, the P matrix is:
$${P}_{12 \times 12} = [ \begin{matrix}{P}_{6 \times 6} & {P}_{6 \times 6} \\ {P}_{6 \times 6} & - {P}_{6 \times 6}\end{matrix} ] , \\ wherein$$
$${P}_{6 \times 6} = [ \begin{matrix}{P}_{3 \times 3} & {P}_{3 \times 3} \\ {P}_{3 \times 3} & - {P}_{3 \times 3}\end{matrix} ] , {P}_{3 \times 3} = [ \begin{matrix}{w}^{0 * 0} & - {w}^{0 * 1} & {w}^{0 * 2} \\ {w}^{1 * 0} & - {w}^{1 * 1} & {w}^{1 * 2} \\ {w}^{2 * 0} & - {w}^{2 * 1} & {w}^{2 * 2}\end{matrix} ] ,$$
and w=exp(−j2π/3).

4. The method according to claim 1, wherein when n=12, the P matrix is:
$${P}_{12 \times 12} = [ \begin{matrix}{P}_{6 \times 6} & {P}_{6 \times 6} \\ {P}_{6 \times 6} & - {P}_{6 \times 6}\end{matrix} ] , \\ wherein$$
$${P}_{6 \times 6} = [ \begin{matrix}{w}^{0 * 0} & - {w}^{0 * 1} & {w}^{0 * 2} & {w}^{0 * 3} & {w}^{0 * 4} & - {w}^{0 * 5} \\ {w}^{1 * 0} & - {w}^{1 * 1} & {w}^{1 * 2} & {w}^{1 * 3} & {w}^{1 * 4} & - {w}^{1 * 5} \\ {w}^{2 * 0} & - {w}^{2 * 1} & {w}^{2 * 2} & {w}^{2 * 3} & {w}^{2 * 4} & - {w}^{2 * 5} \\ {w}^{3 * 0} & - {w}^{3 * 1} & {w}^{3 * 2} & {w}^{3 * 3} & {w}^{3 * 4} & - {w}^{3 * 5} \\ {w}^{4 * 0} & - {w}^{4 * 1} & {w}^{4 * 2} & {w}^{4 * 3} & {w}^{4 * 4} & - {w}^{4 * 5} \\ {w}^{5 * 0} & - {w}^{5 * 1} & {w}^{5 * 2} & {w}^{5 * 3} & {w}^{5 * 4} & - {w}^{5 * 5}\end{matrix} ] , and w = exp ( - j 2 π / 6 ) .$$

5. The method according to claim 1, wherein when n=14, the P matrix is:
$${P}_{14 \times 14} = [ \begin{matrix}{P}_{7 \times 7} & {P}_{7 \times 7} \\ {P}_{7 \times 7} & - {P}_{7 \times 7}\end{matrix} ] , \\ wherein$$
$${P}_{7 \times 7} = [ \begin{matrix}{w}^{0 * 0} & - {w}^{0 * 1} & {w}^{0 * 2} & {w}^{0 * 3} & {w}^{0 * 4} & - {w}^{0 * 5} & {w}^{0 * 6} \\ {w}^{1 * 0} & - {w}^{1 * 1} & {w}^{1 * 2} & {w}^{1 * 3} & {w}^{1 * 4} & - {w}^{1 * 5} & {w}^{1 * 6} \\ {w}^{2 * 0} & - {w}^{2 * 1} & {w}^{2 * 2} & {w}^{2 * 3} & {w}^{2 * 4} & - {w}^{2 * 5} & {w}^{2 * 6} \\ {w}^{3 * 0} & - {w}^{3 * 1} & {w}^{3 * 2} & {w}^{3 * 3} & {w}^{3 * 4} & - {w}^{3 * 5} & {w}^{3 * 6} \\ {w}^{4 * 0} & - {w}^{4 * 1} & {w}^{4 * 2} & {w}^{4 * 3} & {w}^{4 * 4} & - {w}^{4 * 5} & {w}^{4 * 6} \\ {w}^{5 * 0} & - {w}^{5 * 1} & {w}^{5 * 2} & {w}^{5 * 3} & {w}^{5 * 4} & - {w}^{5 * 5} & {w}^{5 * 6} \\ {w}^{6 * 0} & - {w}^{6 * 1} & {w}^{6 * 2} & {w}^{6 * 3} & {w}^{6 * 4} & - {w}^{6 * 5} & {w}^{6 * 6}\end{matrix} ] ,$$
and w=exp(−j2π/7)

6. A method, comprising:
receiving a physical layer protocol data unit (PPDU), wherein the PPDU comprises a matrix-mapped extremely high throughput long training field (EHT LTF) sequence, the matrix-mapped EHT LTF sequence is obtained by multiplying a predefined EHT LTF sequence by a P matrix, the P matrix is an n×n matrix, and n is greater than 8; and
performing channel estimation based on the matrix-mapped EHT LTF sequence.

7. The method according to claim 6, wherein when n=10, the P matrix is:
$${P}_{10 \times 10} = [ \begin{matrix}{P}_{5 \times 5} & {P}_{5 \times 5} \\ {P}_{5 \times 5} & - {P}_{5 \times 5}\end{matrix} ] , \\ wherein {P}_{5 \times 5} = [ \begin{matrix}{w}^{0 * 0} & - {w}^{0 * 1} & {w}^{0 * 2} & {w}^{0 * 3} & {w}^{0 * 4} \\ {w}^{1 * 0} & - {w}^{1 * 1} & {w}^{1 * 2} & {w}^{1 * 3} & {w}^{1 * 4} \\ {w}^{2 * 0} & - {w}^{2 * 1} & {w}^{2 * 2} & {w}^{2 * 3} & {w}^{2 * 4} \\ {w}^{3 * 0} & - {w}^{3 * 1} & {w}^{3 * 2} & {w}^{3 * 3} & {w}^{3 * 4} \\ {w}^{4 * 0} & - {w}^{4 * 1} & {w}^{4 * 2} & {w}^{4 * 3} & {w}^{4 * 4}\end{matrix} ] ,$$
and w=exp(−j2π/5).

8. The method according to claim 6, wherein when n=12, the P matrix is:
$${P}_{12 \times 12} = [ \begin{matrix}{P}_{6 \times 6} & {P}_{6 \times 6} \\ {P}_{6 \times 6} & - {P}_{6 \times 6}\end{matrix} ] , \\ wherein$$
$${P}_{6 \times 6} = [ \begin{matrix}{P}_{3 \times 3} & {P}_{3 \times 3} \\ {P}_{3 \times 3} & - {P}_{3 \times 3}\end{matrix} ] , {P}_{3 \times 3} = [ \begin{matrix}{w}^{0 * 0} & - {w}^{0 * 1} & {w}^{0 * 2} \\ {w}^{1 * 0} & - {w}^{1 * 1} & {w}^{1 * 2} \\ {w}^{2 * 0} & - {w}^{2 * 1} & {w}^{2 * 2}\end{matrix} ] ,$$
and w=exp(−j2π/3).

9. The method according to claim 6, wherein when n=12, the P matrix is:
$${P}_{12 \times 12} = [ \begin{matrix}{P}_{6 \times 6} & {P}_{6 \times 6} \\ {P}_{6 \times 6} & - {P}_{6 \times 6}\end{matrix} ] , \\ wherein$$
$${P}_{6 \times 6} = [ \begin{matrix}{w}^{0 * 0} & - {w}^{0 * 1} & {w}^{0 * 2} & {w}^{0 * 3} & {w}^{0 * 4} & - {w}^{0 * 5} \\ {w}^{1 * 0} & - {w}^{1 * 1} & {w}^{1 * 2} & {w}^{1 * 3} & {w}^{1 * 4} & - {w}^{1 * 5} \\ {w}^{2 * 0} & - {w}^{2 * 1} & {w}^{2 * 2} & {w}^{2 * 3} & {w}^{2 * 4} & - {w}^{2 * 5} \\ {w}^{3 * 0} & - {w}^{3 * 1} & {w}^{3 * 2} & {w}^{3 * 3} & {w}^{3 * 4} & - {w}^{3 * 5} \\ {w}^{4 * 0} & - {w}^{4 * 1} & {w}^{4 * 2} & {w}^{4 * 3} & {w}^{4 * 4} & - {w}^{4 * 5} \\ {w}^{5 * 0} & - {w}^{5 * 1} & {w}^{5 * 2} & {w}^{5 * 3} & {w}^{5 * 4} & - {w}^{5 * 5}\end{matrix} ] ,$$
and w=exp(−j2π/6).

10. The method according to claim 6, wherein when n=14, the P matrix is:
$${P}_{14 \times 14} = [ \begin{matrix}{P}_{7 \times 7} & {P}_{7 \times 7} \\ {P}_{7 \times 7} & - {P}_{7 \times 7}\end{matrix} ] , \\ wherein$$
$${P}_{7 \times 7} = [ \begin{matrix}{w}^{0 * 0} & - {w}^{0 * 1} & {w}^{0 * 2} & {w}^{0 * 3} & {w}^{0 * 4} & - {w}^{0 * 5} & {w}^{0 * 6} \\ {w}^{1 * 0} & - {w}^{1 * 1} & {w}^{1 * 2} & {w}^{1 * 3} & {w}^{1 * 4} & - {w}^{1 * 5} & {w}^{1 * 6} \\ {w}^{2 * 0} & - {w}^{2 * 1} & {w}^{2 * 2} & {w}^{2 * 3} & {w}^{2 * 4} & - {w}^{2 * 5} & {w}^{2 * 6} \\ {w}^{3 * 0} & - {w}^{3 * 1} & {w}^{3 * 2} & {w}^{3 * 3} & {w}^{3 * 4} & - {w}^{3 * 5} & {w}^{3 * 6} \\ {w}^{4 * 0} & - {w}^{4 * 1} & {w}^{4 * 2} & {w}^{4 * 3} & {w}^{4 * 4} & - {w}^{4 * 5} & {w}^{4 * 6} \\ {w}^{5 * 0} & - {w}^{5 * 1} & {w}^{5 * 2} & {w}^{5 * 3} & {w}^{5 * 4} & - {w}^{5 * 5} & {w}^{5 * 6} \\ {w}^{6 * 0} & - {w}^{6 * 1} & {w}^{6 * 2} & {w}^{6 * 3} & {w}^{6 * 4} & - {w}^{6 * 5} & {w}^{6 * 6}\end{matrix} ] ,$$
and w=exp(−j2π/7).

11. An apparatus, comprising:
at least one processor; and
a non-transitory computer-readable storage medium coupled to the at least one processor and storing programming instructions for execution by the at least one processor, the programming instructions instruct the at least one processor to perform operations comprising:
generating a physical layer protocol data unit (PPDU), wherein the PPDU comprises a matrix-mapped extremely high throughput long training field (EHT LTF) sequence, the matrix-mapped EHT LTF sequence is obtained by multiplying a predefined EHT LTF sequence by a P matrix, the P matrix is an n×n matrix, and n is greater than 8; and
sending the PPDU.

12. The apparatus according to claim 11, wherein when n=10, the P matrix is:
$${P}_{10 \times 10} = [ \begin{matrix}{P}_{5 \times 5} & {P}_{5 \times 5} \\ {P}_{5 \times 5} & - {P}_{5 \times 5}\end{matrix} ] , wherein {P}_{5 \times 5} = [ \begin{matrix}{w}^{0 * 0} & - {w}^{0 * 1} & {w}^{0 * 2} & {w}^{0 * 3} & {w}^{0 * 4} \\ {w}^{1 * 0} & - {w}^{1 * 1} & {w}^{1 * 2} & {w}^{1 * 3} & {w}^{1 * 4} \\ {w}^{2 * 0} & - {w}^{2 * 1} & {w}^{2 * 2} & {w}^{2 * 3} & {w}^{2 * 4} \\ {w}^{3 * 0} & - {w}^{3 * 1} & {w}^{3 * 2} & {w}^{3 * 3} & {w}^{3 * 4} \\ {w}^{4 * 0} & - {w}^{4 * 1} & {w}^{4 * 2} & {w}^{4 * 3} & {w}^{4 * 4}\end{matrix} ] ,$$
and w=exp(−j2π/5).

13. The apparatus according to claim 11, wherein when n=12, the P matrix is:
$${P}_{12 \times 12} = [ \begin{matrix}{P}_{6 \times 6} & {P}_{6 \times 6} \\ {P}_{6 \times 6} & - {P}_{6 \times 6}\end{matrix} ] , \\ wherein$$
$${P}_{6 \times 6} = [ \begin{matrix}{P}_{3 \times 3} & {P}_{3 \times 3} \\ {P}_{3 \times 3} & - {P}_{3 \times 3}\end{matrix} ] , {P}_{3 \times 3} = [ \begin{matrix}{w}^{0 * 0} & - {w}^{0 * 1} & {w}^{0 * 2} \\ {w}^{1 * 0} & - {w}^{1 * 1} & {w}^{1 * 2} \\ {w}^{2 * 0} & - {w}^{2 * 1} & {w}^{2 * 2}\end{matrix} ] ,$$
and w=exp(−j2π/3).

14. The apparatus according to claim 11, wherein when n=12, the P matrix is:
$${P}_{12 \times 12} = [ \begin{matrix}{P}_{6 \times 6} & {P}_{6 \times 6} \\ {P}_{6 \times 6} & - {P}_{6 \times 6}\end{matrix} ] , wherein$$
$${P}_{6 \times 6} = [ \begin{matrix}{w}^{0 * 0} & - {w}^{0 * 1} & {w}^{0 * 2} & {w}^{0 * 3} & {w}^{0 * 4} & - {w}^{0 * 5} \\ {w}^{1 * 0} & - {w}^{1 * 1} & {w}^{1 * 2} & {w}^{1 * 3} & {w}^{1 * 4} & - {w}^{1 * 5} \\ {w}^{2 * 0} & - {w}^{2 * 1} & {w}^{2 * 2} & {w}^{2 * 3} & {w}^{2 * 4} & - {w}^{2 * 5} \\ {w}^{3 * 0} & - {w}^{3 * 1} & {w}^{3 * 2} & {w}^{3 * 3} & {w}^{3 * 4} & - {w}^{3 * 5} \\ {w}^{4 * 0} & - {w}^{4 * 1} & {w}^{4 * 2} & {w}^{4 * 3} & {w}^{4 * 4} & - {w}^{4 * 5} \\ {w}^{5 * 0} & - {w}^{5 * 1} & {w}^{5 * 2} & {w}^{5 * 3} & {w}^{5 * 4} & - {w}^{5 * 5}\end{matrix} ] ,$$
and w=exp(−j2π/6).

15. The apparatus according to claim 11, wherein when n=14, the P matrix is:
$${P}_{14 \times 14} = [ \begin{matrix}{P}_{7 \times 7} & {P}_{7 \times 7} \\ {P}_{7 \times 7} & - {P}_{7 \times 7}\end{matrix} ] , wherein$$
$${P}_{7 \times 7} = [ \begin{matrix}{w}^{0 * 0} & - {w}^{0 * 1} & {w}^{0 * 2} & {w}^{0 * 3} & {w}^{0 * 4} & - {w}^{0 * 5} & {w}^{0 * 6} \\ {w}^{1 * 0} & - {w}^{1 * 1} & {w}^{1 * 2} & {w}^{1 * 3} & {w}^{1 * 4} & - {w}^{1 * 5} & {w}^{1 * 6} \\ {w}^{2 * 0} & - {w}^{2 * 1} & {w}^{2 * 2} & {w}^{2 * 3} & {w}^{2 * 4} & - {w}^{2 * 5} & {w}^{2 * 6} \\ {w}^{3 * 0} & - {w}^{3 * 1} & {w}^{3 * 2} & {w}^{3 * 3} & {w}^{3 * 4} & - {w}^{3 * 5} & {w}^{3 * 6} \\ {w}^{4 * 0} & - {w}^{4 * 1} & {w}^{4 * 2} & {w}^{4 * 3} & {w}^{4 * 4} & - {w}^{4 * 5} & {w}^{4 * 6} \\ {w}^{5 * 0} & - {w}^{5 * 1} & {w}^{5 * 2} & {w}^{5 * 3} & {w}^{5 * 4} & - {w}^{5 * 5} & {w}^{5 * 6} \\ {w}^{6 * 0} & - {w}^{6 * 1} & {w}^{6 * 2} & {w}^{6 * 3} & {w}^{6 * 4} & - {w}^{6 * 5} & {w}^{6 * 6}\end{matrix} ] ,$$
and w=exp(−j2π/7).

16. An apparatus, comprising:
at least one processor; and
a non-transitory computer-readable storage medium coupled to the at least one processor and storing programming instructions for execution by the at least one processor, the programming instructions instruct the at least one processor to perform operations comprising:
receiving a physical layer protocol data unit (PPDU), wherein the PPDU comprises a matrix-mapped extremely high throughput long training field (EHT LTF) sequence, the matrix-mapped EHT LTF sequence is obtained by multiplying a predefined EHT LTF sequence by a P matrix, the P matrix is an n×n matrix, and n is greater than 8; and
performing channel estimation based on the matrix-mapped EHT LTF sequence.

17. The apparatus according to claim 16, wherein when n=10, the P matrix is:
$${P}_{10 \times 10} = [ \begin{matrix}{P}_{5 \times 5} & {P}_{5 \times 5} \\ {P}_{5 \times 5} & - {P}_{5 \times 5}\end{matrix} ] , wherein {P}_{5 \times 5} = [ \begin{matrix}{w}^{0 * 0} & - {w}^{0 * 1} & {w}^{0 * 2} & {w}^{0 * 3} & {w}^{0 * 4} \\ {w}^{1 * 0} & - {w}^{1 * 1} & {w}^{1 * 2} & {w}^{1 * 3} & {w}^{1 * 4} \\ {w}^{2 * 0} & - {w}^{2 * 1} & {w}^{2 * 2} & {w}^{2 * 3} & {w}^{2 * 4} \\ {w}^{3 * 0} & - {w}^{3 * 1} & {w}^{3 * 2} & {w}^{3 * 3} & {w}^{3 * 4} \\ {w}^{4 * 0} & - {w}^{4 * 1} & {w}^{4 * 2} & {w}^{4 * 3} & {w}^{4 * 4}\end{matrix} ] ,$$
and w=exp(−j2π/5).

18. The apparatus according to claim 16, wherein when n=12, the P matrix is:
$${P}_{12 \times 12} = [ \begin{matrix}{P}_{6 \times 6} & {P}_{6 \times 6} \\ {P}_{6 \times 6} & - {P}_{6 \times 6}\end{matrix} ] , wherein$$
$${P}_{6 \times 6} = [ \begin{matrix}{P}_{3 \times 3} & {P}_{3 \times 3} \\ {P}_{3 \times 3} & - {P}_{3 \times 3}\end{matrix} ] , {P}_{3 \times 3} = [ \begin{matrix}{w}^{0 * 0} & - {w}^{0 * 1} & {w}^{0 * 2} \\ {w}^{1 * 0} & - {w}^{1 * 1} & {w}^{1 * 2} \\ {w}^{2 * 0} & - {w}^{2 * 1} & {w}^{2 * 2}\end{matrix} ] ,$$
and w=exp(−j2π/3).

19. The apparatus according to claim 16, wherein when n=12, the P matrix is:
$${P}_{12 \times 12} = [ \begin{matrix}{P}_{6 \times 6} & {P}_{6 \times 6} \\ {P}_{6 \times 6} & - {P}_{6 \times 6}\end{matrix} ] , wherein {P}_{6 \times 6} = [ \begin{matrix}{w}^{0 * 0} & - {w}^{0 * 1} & {w}^{0 * 2} & {w}^{0 * 3} & {w}^{0 * 4} & {w}^{0 * 5} \\ {w}^{1 * 0} & - {w}^{1 * 1} & {w}^{1 * 2} & {w}^{1 * 3} & {w}^{1 * 4} & {w}^{1 * 5} \\ {w}^{2 * 0} & - {w}^{2 * 1} & {w}^{2 * 2} & {w}^{2 * 3} & {w}^{2 * 4} & {w}^{2 * 5} \\ {w}^{3 * 0} & - {w}^{3 * 1} & {w}^{3 * 2} & {w}^{3 * 3} & {w}^{3 * 4} & {w}^{3 * 5} \\ {w}^{4 * 0} & - {w}^{4 * 1} & {w}^{4 * 2} & {w}^{4 * 3} & {w}^{4 * 4} & {w}^{4 * 5} \\ {w}^{5 * 0} & - {w}^{5 * 1} & {w}^{5 * 2} & {w}^{5 * 3} & {w}^{5 * 4} & {w}^{5 * 5}\end{matrix} ] ,$$
and w=exp(−j2π/6).

20. The apparatus according to claim 16, wherein when n=14, the P matrix is:
$${P}_{14 \times 14} = [ \begin{matrix}{P}_{7 \times 7} & {P}_{7 \times 7} \\ {P}_{7 \times 7} & - {P}_{7 \times 7}\end{matrix} ] , wherein$$
$${P}_{7 \times 7} = [ \begin{matrix}{w}^{0 * 0} & - {w}^{{0}^{*} 1} & {w}^{{0}^{*} 2} & {w}^{{0}^{*} 3} & {w}^{{0}^{*} 4} & - {w}^{{0}^{*} 5} & {w}^{{0}^{*} 6} \\ {w}^{{1}^{*} 0} & - {w}^{{1}^{*} 1} & {w}^{{1}^{*} 2} & {w}^{{1}^{*} 3} & {w}^{{1}^{*} 4} & - {w}^{{1}^{*} 5} & {w}^{{1}^{*} 6} \\ {w}^{{2}^{*} 0} & - {w}^{{2}^{*} 1} & {w}^{{2}^{*} 2} & {w}^{{2}^{*} 3} & {w}^{{2}^{*} 4} & - {w}^{{2}^{*} 5} & {w}^{{2}^{*} 6} \\ {w}^{{3}^{*} 0} & - {w}^{{3}^{*} 1} & {w}^{{3}^{*} 2} & {w}^{{3}^{*} 3} & {w}^{{3}^{*} 4} & - {w}^{{3}^{*} 5} & {w}^{{3}^{*} 6} \\ {w}^{{4}^{*} 0} & - {w}^{{4}^{*} 1} & {w}^{{4}^{*} 2} & {w}^{{4}^{*} 3} & {w}^{{4}^{*} 4} & - {w}^{{4}^{*} 5} & {w}^{{4}^{*} 6} \\ {w}^{{5}^{*} 0} & - {w}^{{5}^{*} 1} & {w}^{{5}^{*} 2} & {w}^{{5}^{*} 3} & {w}^{{5}^{*} 4} & - {w}^{{5}^{*} 5} & {w}^{{5}^{*} 6} \\ {w}^{{6}^{*} 0} & - {w}^{{6}^{*} 1} & {w}^{{6}^{*} 2} & {w}^{{6}^{*} 3} & {w}^{{6}^{*} 4} & - {w}^{{6}^{*} 5} & {w}^{{6}^{*} 6}\end{matrix} ] ,$$
